(19) United States
(12) Patent Application Publication
(10) Pub. No.: US 2013/0311245 A1
(43) Pub. Date: Nov. 21, 2013

(54) SYSTEM AND METHOD FOR GAMIFYING PERSONAL DEVELOPMENT

(71) Applicant: SALESFORCE.COM, INC., (US)

(72) Inventors: Jenny Blackburn, San Francisco, CA (US); Kenneth Douglas Scott, Alameda, CA (US); Mrudula Kodali, San Francisco, CA (US)

(73) Assignee: SALESFORCE.COM, INC., San Francisco, CA (US)

(21) Appl. No.: 13/886,701

(22) Filed: May 3, 2013

Related U.S. Application Data
(60) Provisional application No. 61/641,958, filed on May 3, 2012.

(51) Int. Cl. G06Q 10/06

(52) U.S. Cl. CPC G06Q 10/06393
USPC 705/7.39

(57) ABSTRACT

In accordance with embodiments, mechanisms and methods are provided for gamifying personal development. The mechanisms and methods for gamifying personal development may enable embodiments to provide a technique for encouraging behaviors or skills in the work place through competitions and game theory often associated with games. The mechanisms and methods for gamifying personal development can include employees/players taking challenges and creating challenges. The mechanisms and methods for gamifying personal development can include a point economy in which the employee/player accumulates player and/or creator points, and obtains privileges may be assigned based on the number of points awarded in a particular topic area.

### CLAIM OF PRIORITY

This application claims the benefit of U.S. Provisional Patent Application 61/641,958 entitled SYSTEM AND METHOD FOR GAMIFYING PERSONAL DEVELOPMENT, by Blackburn, et al., filed May 3, 2012 (Attorney Docket No. 873PROV), the entire contents of which are incorporated herein by reference.

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. Provisional Patent Application 61/641,958 entitled SYSTEM AND METHOD FOR GAMIFYING PERSONAL DEVELOPMENT, by Blackburn, et al., filed May 3, 2012 (Attorney Docket No. 873PROV)

U.S. patent application Ser. No. 13/886,701 entitled SYSTEM AND METHOD FOR GAMIFYING PERSONAL DEVELOPMENT, by Jenny Blackburn et al., filed May 3, 2013 Attorney Docket No. 48-86/873US.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to providing a system and method for gamifying personal development.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many businesses use traditional training and development methods for workers to learn skills related to their jobs. These methods have been shown to be labor intensive and less successful then expected. Methods are needed for businesses to more successfully teach skills to workers.

### SUMMARY OF THE INVENTION

In accordance with embodiments, there are provided mechanisms and methods for gamifying personal development. The mechanisms and methods for gamifying personal development may enable embodiments to provide a technique for encouraging behaviors or skills in the work place through competitions and game theory often associated with games. The mechanisms and methods for gamifying personal development may include employees/players taking challenges and creating challenges. The mechanisms and methods for gamifying personal development may include a point economy in which the employee/player accumulates player and/or creator points.

The method includes receiving a request to take or create a challenge associated with an aspect of the company, business, work-based skills, and/or general skills. In response to receiving the request, a user-interface for taking or creating a challenge is sent from a host machine. The player plays the challenge and/or creates a challenge and submits the results of the challenge. In response, the host machine sends the results to a reviewer. The reviewer may be a user/player from the same company. The reviewer submits the review to the host machine. The review is sent to the player. The review may be sent with the points that have been granted to the player. The reviewer may decide whether the challenge will be created and offered to other players. The player may accumulate points to receive privileges and the points may be stored at the host machine. One privilege a player may receive is to become a challenge reviewer.

Although in an embodiment the method and system for gamifying personal development is implemented via an on-demand multitenant database, the method and system for gamifying personal development is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an example of a system for gamifying personal development using an on-demand database service;

FIG. 2A is a flow diagram illustrating an embodiment of a user-side method of taking a challenge.

FIG. 2B is an flow diagram illustrating an embodiment of a server-side method of taking a challenge in a method for gamifying personal development.

FIG. 3A is a flow diagram illustrating an embodiment of a user-side method of creating a challenge in a method for gamifying personal development.

FIGS. 3B and 3C are flow diagrams illustrating an embodiment of a server-side method of creating a challenge in a method for gamifying personal development.

FIG. 3D is a flow diagram illustrating an embodiment of a user-side method of creating a challenge in a method for gamifying personal development.

FIG. 4A is an flow diagram illustrating an embodiment of the details of a user-side method of creating a challenge for a method for gamifying personal development;

FIG. 4B FIG. an flow diagram illustrating an embodiment of the details of a server-side method of creating a challenge for a method for gamifying personal development;

FIG. 5 is a webpage illustrating an embodiment of an introductory webpage for methods for gamifying personal development.

FIG. 6 is a webpage illustrating an embodiment of a take a challenge webpage for methods for gamifying personal development.

FIG. 7 is a webpage illustrating an embodiment of a challenge webpage for methods for gamifying personal development.

FIG. 8 is a webpage illustrating an embodiment of a take a challenge webpage for methods for gamifying personal development.

FIG. 9 is a webpage illustrating an embodiment of a create a challenge webpage for methods for gamifying personal development.

FIG. 10 is a webpage illustrating an embodiment of a create a challenge webpage for methods for gamifying personal development.

FIG. 11 is a webpage illustrating an embodiment of a create a challenge webpage for methods for gamifying personal development.

FIG. 12 is a webpage illustrating an embodiment of a challenge template webpage for methods for gamifying personal development.

FIG. 13 is a webpage illustrating an embodiment of an open challenge webpage for methods for gamifying personal development.

FIG. 14 is a webpage illustrating an embodiment of a challenge template webpage for methods for gamifying personal development.

FIG. 15 is a webpage illustrating an embodiment of a submission webpage for methods for gamifying personal development.

FIGS. 16A and 16B are portions of a webpage illustrating an embodiment of a definition webpage for methods for gamifying personal development.

FIGS. 17A, 17B and 17C are portions of a webpage illustrating an embodiment of a success webpage for methods for gamifying personal development.

FIGS. 18A and 18B are portions of a webpage illustrating an embodiment of an additional webpage for methods for gamifying personal development.

FIGS. 19A and 19B are portions of a webpage illustrating an embodiment of a preview webpage for methods for gamifying personal development.

FIG. 20 is a webpage illustrating an embodiment of a creator webpage for methods for gamifying personal development.

FIG. 21 is a webpage illustrating an embodiment of a thank you webpage for methods for gamifying personal development.

FIG. 22 is a webpage illustrating an embodiment of a thank you webpage for methods for gamifying personal development.

FIG. 23 is a diagram illustrating a method of awarding points for a system and method for gamifying personal development.

FIG. 24 is an flow diagram illustrating a method of awarding points for gamifying personal development in an embodiment.

FIG. 25 illustrates a block diagram of a server for a method and system of gamifying personal development in an embodiment;

FIG. 26 illustrates a block diagram of a system in which an on-demand database service may be used.

FIG. 27 illustrates an embodiment of the environment of FIG. 26 and various possible interconnections between these elements;

FIG. 28 illustrates a flow diagram of an example of a method of using the environment of FIG. 26;

FIG. 29 illustrates a flow diagram of an example of a method of making the environment of FIG. 26.

### DETAILED DESCRIPTION

### General Overview

Systems and methods are provided for gamifying personal development. In at least one embodiment, the system and methods are for incentivizing learning and development through the award of points and privileges. “Gamification” is a technique for encouraging behaviors through playing games, competition, and game theory.

Game Theory is the study of mathematical models that drive conflict or cooperation decision making in people. Specifically, by the system of this specification creates an economic system for achievement and ownership within the environment of the game and by the nature of providing the financial levers (that is financial with the virtual economics of the game environment) to drive more or less cooperation in the economic system of the game implementers of the system may incorporate and/or use various game theory models as the implementers wish. For example, the system may be configured to have a “zero sum” economy with a fixed number of points that can be awarded to players (which in an embodiment may be employees) and there may be a fixed number of challenge creators that are allowed. Placing a limit on the number of points and challenge creators that may be awarded creates a competitive environment (versus cooperative environment) among challenge creators and among challenge players. As a result of the fixed number of points and challenge creators, each player attempts to capture as many of the limited points that the player can, and each creators attempts to encourage all the challenge takers to taker with the challenges created by that challenge creator. Alternatively, the implementer may configure the system to create a more social/political economy that does not have a fixed number of points and/or challenges and/or in which points and/or challenges may also be awarded based on certain cooperative behaviors, such as joining a team and/or contributing to a team effort. By having looser virtual financial levers that allow new players to gain the ability to distribute, review, and create challenges (e.g., having read ownership) existing challenge creators who worked together to maintain ownership and control of the game may benefit by coordinating to attract the attention of players, and possibly working together to limit the number of new owners allowed in the game. In essence, the company implementing the game for their employees may, via various settings, configure the game to conform with a particular game theory model that fits the company's situation and culture to accentuate or even change the behavior of the company's employees by modifying the virtual financial incentive structures within the game.

With respect to learning and expertise development, one or more implementations are directed to encouragement using particular aspects of gamification. However, the system and methods are not merely the addition of a “game overlay” to traditional training and development. Instead, the system and methods of gamifying personal development include a completely separate experience where the paradigm shifts to player ownership and the process by which an employee/“player” comes to “own” a particular content area. The player moves from a consumer of the content and the game experience to a creator. As such, one or more implementations include mechanisms for creating a challenge.

One or more implementations include a “point economy,” which is a structure by which one or more players accumulate player and creator points and mastery of the game. One or more implementations include a user interface. The following figures illustrate various implementation features and algorithms, but are not intended to limit this disclosure to any particular implementation.

The system and method for gamifying personal development supplies a game framework for encouraging experiential learning and content mastery. Via the creating and taking of challenges, competition ensues. By amassing points, topic areas leaders are created who can attempt to contain and control the scope and importance of future topics. A community of experts emerges which compete for content relevance and compete for impact on the professional development of the larger organization. In other words, the challenge taker and/or creator becomes an expert in a particular topic area and may then have an influence as to what direction challenges in that topic area take. The direction that challenges take may influence the direction the company takes in that topic area. As a result of winning points, the player may be awarded a higher level of access to tools for evaluating the games made by others. For example, the player may be granted tools for exercising veto power over certain activities (such as whether or not a challenge may be written and/or published), as a result of winning more points. The player's vote (e.g., as to whether to publish a challenge or whether to allow another player to write a challenge) may be weighted with a higher value, as a result of winning more points. The player may be given tools for awarding points to others, as a result of winning more points.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. In an embodiment, each tenant has access to a portion of the database as a result of the tenant's tenancy. Each tenant may have their own employees, officers, and customers, whom may have a level of access to the multitenant database via the tenant's access to the multitenant database. In an embodiment, the multitenant database is an on-demand relational database, which is a relational database that is provided as a service. The tenant only needs to learn to interact with the interface of the on-demand multitenant database, but does not need to worry about maintaining the database or learn any database language. As used herein, the term query plan refers to a set of steps used to access information in a database system.

Next, mechanisms and methods for providing systems and methods are provided for gamifying personal development will be described with reference to example embodiments.

The following detailed description will first describe systems and methods for gamifying personal development in accordance with aspects and embodiments. Webpages for embodiments of systems and methods for gamifying personal development are then detailed. Following the description of a server and system for gamifying personal development is described.

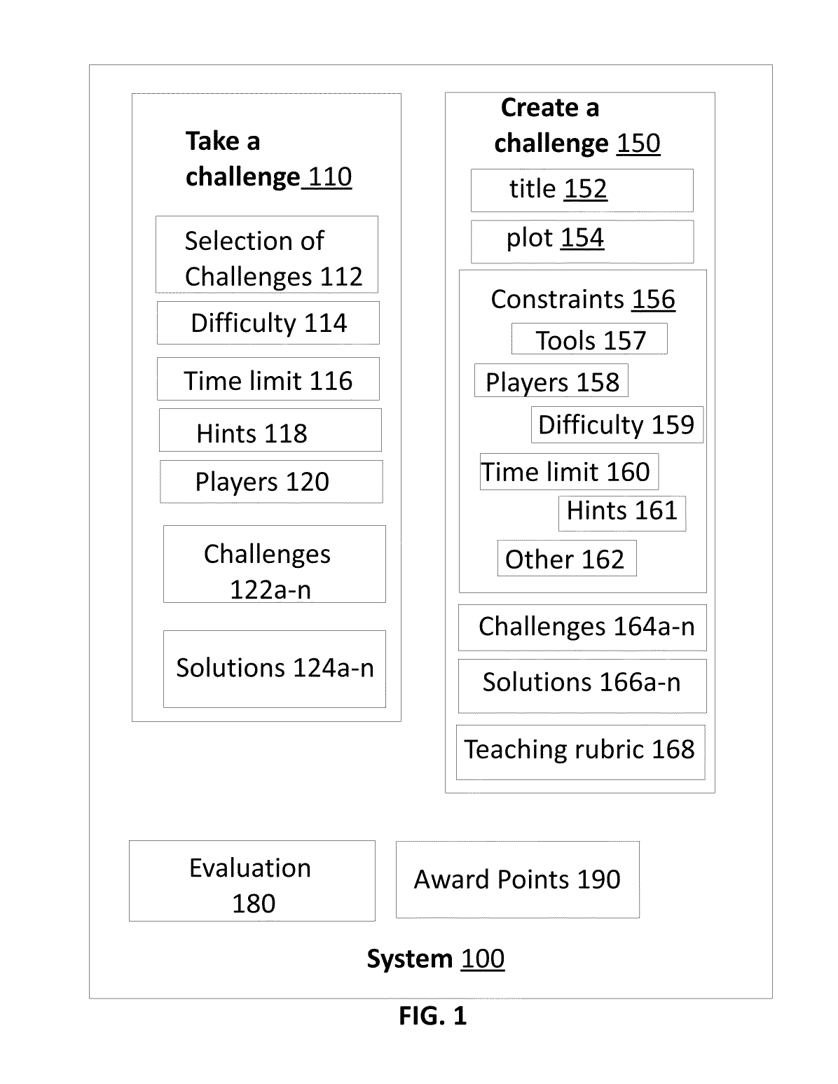

FIG. 1 illustrates a block diagram of an embodiment of a system 100 for methods of gamifying personal development which may include embodiments of take a challenge 110, which includes selection of challenges 112, difficulty 114, player time limit 116, hints 118, players 120, challenges 122a-n, and solutions 124a-n. System 100 also includes create a challenge 150, which includes, title 152, plot 154, and constraints 156 including tools 157, players 158, difficulty 159, creator time limit 160, hints 161, and other 162. Create a challenge 150 also includes challenges 164a-n, solutions 166a-n, reviewer players 168, points/privileges 170, and teaching rubric 172. The system 100 also includes evaluation 180 and award points 190. The elements previously listed will be discussed in detail subsequently in the specification. In other embodiments, system 100 may not have all of the elements or components listed above and/or may have other elements or components instead of or in addition to those listed.

In at least one embodiment, the system 100 includes tools for taking and/or creating challenges for systems and methods of gamifying personal development. The different elements of system 100 may also correspond to different elements of the program underlying system 100.

Take a challenge 110 provides tools that allow a user to take a challenge.

Selection of challenges 112 functions to provide a page having a selection of challenges that users can search and select. The selection of challenges 112 may be provided as a table of available challenges that a user may select, which may include a searchable field, such as an ordered list. The selection of challenges 112 may be searchable by category (e.g., language, computer language, computer program, sensitivity, company, safety, health, etc.), by job title (programmer, lawyer, HR, management, finance, etc.), by the title of the challenge, by the creator of the challenge, by the difficulty (e.g., easy, medium, hard), by the time limit, by the number of players (one, two, three, four, etc.), by the number of points, by the popularity of the challenge (e.g., by number of people who have taken the challenge and/or by the ratings given to the challenge by those that took the challenge and/or wrote the challenge), by the topic area, focus difficulty, and/or tools.

The difficulty 114 of the challenge may be based on a number of factors, including but not limited to, the difficulty of the subject matter, the time limit, the number of hints, the expertise required to play the challenge, and/or the technical ability required to take the challenge, for example. In at least one embodiment, input from players and/or creators may be used to ascertain the difficulty of the challenge.

The player time limit 116 may be any amount of time that is believed to be reasonable by the business or company. In at least one embodiment, the time limit may be from 1 min to 1 month, including but not limited to 2 min, 3 min, 4 min, 5 min, 6 min, 7 min, 8 min, 9 min, 10 min, 15 min, 20 min, 25 min, 30 min, 35 min, 40 min, 45 min, 50 min, 55 min, 60 min, 1.5 hours, 2 hours, 3 hours, 4 hours, 5 hours, 6 hours 7 hours, 8 hours, 9 hours, 10 hours, 11 hours, 12 hours, 13 hours, 14, hours, 15, hours, 16 hours, 17 hours, 18 hours, 19 hours, 20 hours, 21 hours, 22 hours, 23 hours, 1 day, 2 days, 3 days, 4 days, 5 days, 10 days, 15 days, 20 days, 25 days, 30 days, 1 month, 3, months, 6 months, 9 months, and 1 year. In at least one embodiment, the time limit may be more than one month. In at least one embodiment, the time limit is measured in one sitting. In other words, the challenge must be taken from start to finish in one sitting. In at least one embodiment, the challenge may be taken in a finite number of sittings. The challenge may explain to the user what the rules are related to the time limit and the number of sittings before or after opening the challenge. If the user takes longer than the time limit to finish the challenge, the user may be docked points, may lose the challenge and/or may have to start over. Alternatively, there may be levels of a particular challenge that vary from easy to difficult and the user may be sent back to the easier challenge if the user goes over the time limit.

The hints 118 in relation to the challenge player may be any hints that may help the user to finish the challenge. The hints are discussed in more detail in FIG. 1 (see 161) in relation to creating the challenge.

The players 120 may also be users and/or may be employees of the company. The players 120 may also function as reviewers. The user is also a player because the challenge is a game. Players 120 may take challenges alone or may work in groups of two or more depending on the challenge. The terms player, user, and employee may be used interchangeably in the specification. A player may also be referred to as a “taker” when the player is taking a challenge.

Challenges 122a-n may include any competition or game that involves encouraging behaviors associated with work-based skills. While teaching methods such as those used in certification programs have some value, they do not teach problem solving. Thus, in at least one embodiment, the challenges allow for practice and failure and failure is encouraged. In at least one embodiment, the work-based skills may be hard skills (e.g., computer language, computer program, knowledge of technology, laws, languages, etc.) or soft skills (management, leadership, HR, sensitivity training, anger management, working as a team, etc.). In at least one embodiment, the challenge provides declarative knowledge, conceptual knowledge, rules-based knowledge, procedural knowledge, and/or soft skill knowledge. The challenge may be specific to the user's job (e.g., how Java works). Challenges may be secure and/or role-based. In other words, there may be challenges specific to managers that may only be seem or taken by managers in the workplace. The challenge may be specific to the company, such that a new hire may learn more about the company by taking a challenge. The challenge may be specific to teams and encourage players to work together. In other words, the challenge may require teams to work together to take a challenge and/or to identify a solution.

The solutions 124a-n with respect to the challenge taker is the way to finish, accumulate points and/or win the challenge and may be specific to each of the challenges. See solutions 166a-n in FIG. 1 for more about the solutions in relation to the challenge creation.

Create a challenge 150 provides tools that allow a user to create a challenge. The user that creates a challenge may be called a creator. The challenge may be specific to the user's job and may provide work-based skills and/or general skills to the user and to players that take the finished challenge. In addition, creating the challenge may provide work-based skills and/or general skills to the user that creates the challenge. The terms player, user, and employee may be used interchangeably in this specification. A player may also be referred to as a “creator” when the player is creating a challenge. The terms player, user, and employee may be used interchangeably in the specification. A player may also be referred to as a “creator” when the player is creating a challenge.

The title 152 of the challenge may be chosen and input by the user (the challenge creator) based on the type of challenge, the difficulty, the time limit, the topic, the plot (e.g., the story line), etc. The title 152 of the challenge may be constrained by certain rules based on the ability to list and/or search for the challenges (see selection of challenges 112). A teaching rubric may (among other things) provide the user with information about how to choose a workable and/or interesting title for a challenge.

The plot 154 of the challenge may be chosen by the user (the challenge creator or player). The plot 154 may be chosen to teach an aspect of work skills, personal development, job performance, or general knowledge. A teaching rubric may provide the user with information about how to choose a workable and/or interesting plot for a challenge. Alternatively, the plot 154 may be analyzed by the reviewer and a number of points given to the challenge creator based on the analysis.

Constraints 156 for a challenge may be any aspect that makes the challenge a challenge. Constraints may be rules. Constraints may be used to decide the difficulty of a challenge. Constraints may include tools, difficulty, player numbers, player types, time limit, etc. A teaching rubric may provide the user with information about how to choose constraints, the level of the constraints, the difficulty of the constraints, etc.

Tools 157 may be completely or partially chosen by the challenge creator may be constraints that a user must know before taking the challenge. The tools may include a language, a computer language, a computer program, some type of technical knowledge (e.g., business, finance, science, psychology), or a job level such as management. A teaching rubric may provide the user with information about how to choose tools.

The number and type of players 158 may be completely or partially chosen by the challenge creator. The type of player may refer to the level in the company (e.g., management, new employee), or the type of job (e.g., computer analyst, lawyer, secretary, banker). A teaching rubric may provide the user with information about how to choose the number and type of players 158.

The difficulty 159 may be completely or partially chosen by the challenge creator. The difficulty 159 of the challenge may be at least partially decided by the subject matter, the plot, the time limit, the number or type of hints, the type of player, the skills needed, the knowledge needed, etc. The difficulty 159 of the challenge may be used to decide the number of points the challenge creator earns. A teaching rubric may provide the user with information about how to make the challenge conform to a level of difficulty.

Creator time limit 160 for the challenge creator may be the amount of time the creator uses or takes to create the challenge. In at least one embodiment, the teaching rubric may provide the challenge creator with a time limit for creating the challenge. The amount of time the creator takes to create the challenge may be used by the reviewer to decide the number of points awarded. When creating the challenge, a teaching rubric may provide the user/creator with information about how to decide the various aspects of the time limit for the challenge, when creating the challenge.

Hints 161 in relation to the creator may be constraints that the creator chooses to include in the challenge for the user to use. Hints may be made optional or mandatory. Hints 161 may help the user to finish the challenge. The hints 161 may allow the user to finish the challenge more quickly or more successfully. The hints 161 may be automatically set to appear at various times throughout the challenge. The hints 161 may set to appear at specific time points, when specific mistakes are made, or if the user has not reached a certain place in the challenge by a specific time. The hints may be mandatory or optional. In at least one embodiment, the hints may appear as boxes that, when opened, provide the user with a useful hint. In at least one embodiment, when the hints appear, the user may choose to view the hints or not to view the hints. Optionally, the hints may not appear automatically, but may be chosen by the user when needed. The hints may be boxes or links that are always shown on the webpage that may be opened as needed. The hint boxes may include some explanation of the type of hint, the number of points that will be docked if the hint is used, the popularity of the hint and/or other information useful to the user to decide if the user wants to open the hint. In at least one embodiment, the number of hints the user needs to complete the challenge may be used to formulate the number of points the user accumulates from completion of the challenge. The teaching rubric may provide the user with information about how to decide the various aspects of the hints.

Other 162 may be any constraints that have not already been discussed. Constraints may be constraints on the challenge maker or constraints that the challenge maker places on the player. Some examples of constraints on the challenge submission may include length, format (doc or jpg or txt), language used (Java, c, etc), delivery (by hand, mail, pony express) or constraints on how the challenge is completed such as with a buddy or alone, while wearing a costume, or over 5 days in 5 minute increments each day.

The challenges 164a-n may be the final product or a work in progress that is created. In at least one embodiment, a given challenge may be kept from other users until the reviewer decides the challenge may be shared with other users. The challenges 164a-n may include any competition or game that involves encouraging behaviors and/or developing skills that are beneficial for the work environment. In at least one embodiment, the skills that are beneficial for the work environment may be hard skills (e.g., computer language, computer program, knowledge of technology, laws, languages, etc.) or soft skills (management, leadership, HR, sensitivity training, anger management, working as a team, etc.). The challenge may be specific to the user's job (e.g., how Java works). Challenges may be secure and/or role-based. In other words, there may be challenges specific to managers that may only be taken or seen by managers in the workplace. The challenge may be specific to the company, such that a new hire may learn more about the company by taking a challenge. The challenge may be specific to teams. In other words, the challenge may require teams to work together to take a challenge.

Solutions 166a-n in relation to the challenge creator may be partially or completely chosen by the challenge creator. Solutions may be may be specific to the challenges. The solutions 124a-n may be reviewed by the reviewer player(s). The solutions 124a-n may be very specific or general. The solutions 124a-n may be subjective and may need to be reviewed and rated by the reviewer. In at least one embodiment, a challenge may have more than one solution and/or may have levels of solutions. By levels of solutions, it is meant that some of the solutions may be better or more sophisticated than other solutions. The solutions may be reviewed by the reviewer player. The solutions may involve problem solving techniques. In the case of the create a challenge aspect, the solutions 166a-n may be the challenge(s) that the player has created.

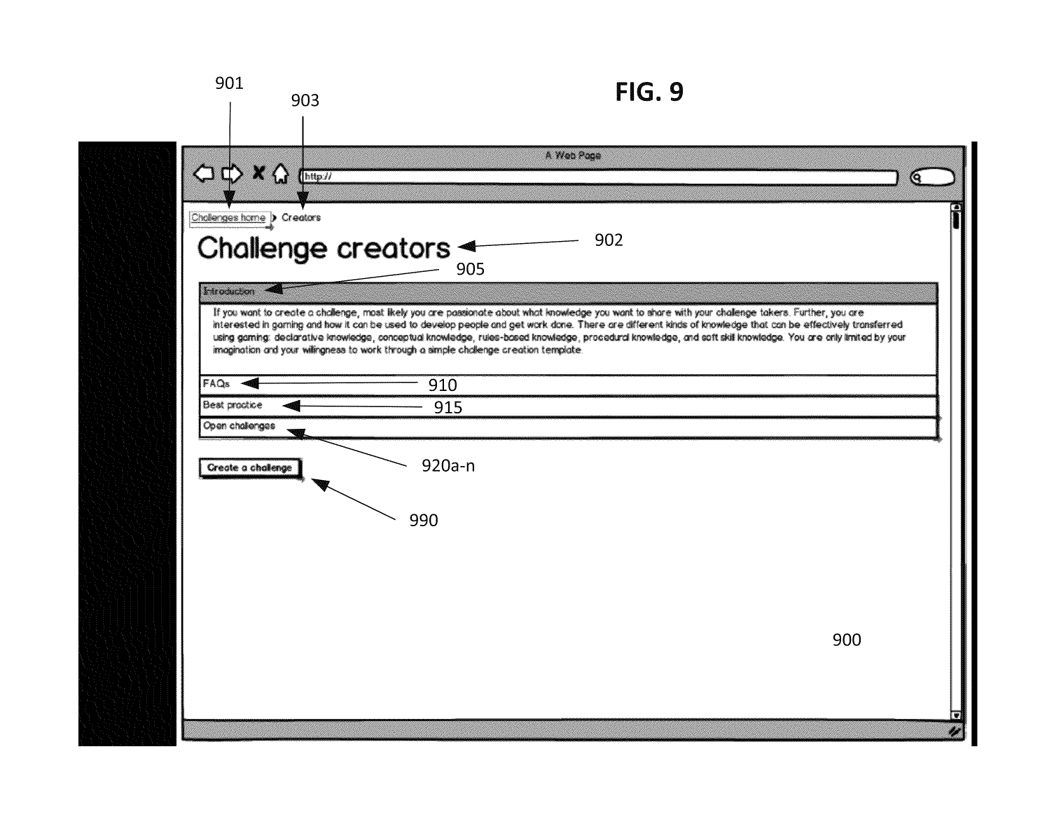

The teaching rubric 172 may be a set of instructions on how to create a challenge that is presented to the user in a particular order. The teaching rubric 172 may function to get the writer engaged in writing a challenge. The instructions in the teaching rubric 172 may lead a user through the process at various ability levels. In at least one embodiment, by creating the challenge, the user learns how to create a challenge that will be useful to gamify personal development. In creating the challenge, the user may increase the user's work-based skills. The teaching rubric may walk the challenge creator through the process of creating a challenge in a step-by-step manner. An example of how the teaching rubric is used to help a user create a challenge is shown in FIGS. 9-22.

The evaluation 180 for a challenge is a software and/or storage area. The evaluation 180 includes an interface to perform the evaluation, a storage area for storing the evaluations, and/or software for presenting the evaluations to the user. In at least one embodiment, the evaluation may be provided to the evaluation software by a reviewer player or a challenge reviewer. Thus, the evaluation 180 for a challenge that has been taken or for a challenge that has been created may be provided by one or more reviewer player(s). The evaluation 180 may include an authentication process to check whether the submitter of the evaluation (the reviewer player) has the privilege to be a reviewer for that specific challenge. The evaluation may be based on the number of points that the user has in a particular file, the topic area, and/or votes from other users to extend evaluation privileges to the user and/or to make the user a reviewer. Reviewer player(s) may be one or more players/users from the same company that review the solution(s). The reviewer player (also called the reviewer) may have a particular expertise that allows the reviewer to be a reviewer. The player may earn the right to be a reviewer player based on the challenges the player has played, the challenges the player has created, the number of points the player has received (both taking and creating challenges), etc. Becoming a reviewer player may be one of the privileges that is earned based on the number of points. In at least one embodiment, the reviewer player may input the review into the system and include comments, suggestions, points, and/or the solution to be saved and then submitted to the player or challenge creator.

Award points 190 may involve awarding points based on a number of aspects of the challenges—both for taking a challenge and for creating a challenge. Award points 190 can be a software and/or storage area. Award points 190 can includes an interface to award points based on an algorithm and/or the review, a storage area for storing the points, and/or software for keeping track of the points and the point system. The points 128 function as a game economy for the challenges. The points 128 may be paired with privileges or may be used to provide privileges. In other words, the privileges may be given based on the number of points a player accrues. The game economy may be based on a constrained number of points that the players compete for. The points 128 may be accumulated based on the number of challenges, the level of challenges, the number of hints used, the difficulty of the challenges, the time used per challenge, the solutions, etc. The number of points a player is given may be decided by the reviewer and/or an algorithm. The awarding of the points may be subjective or nonsubjective. In at least one embodiment, the subjective awarding of points may be by the reviewer based on the successful completion of the challenge and/or the materials submitted with the challenge. In at least one embodiment, the non-subjective awarding of the points is by an algorithm. The non-subjective algorithm may award points based on such parameters as complexity and/or difficulty of the challenge, hints used, time used, answers (correct or wrong), how many challenges the user has taken, how many times the user has taken the specific challenge, and/or how many challenges the user has created. Failure may be encouraged by the awarding of points based on the number of challenges a user takes (without specifying if the challenge was re-taken).

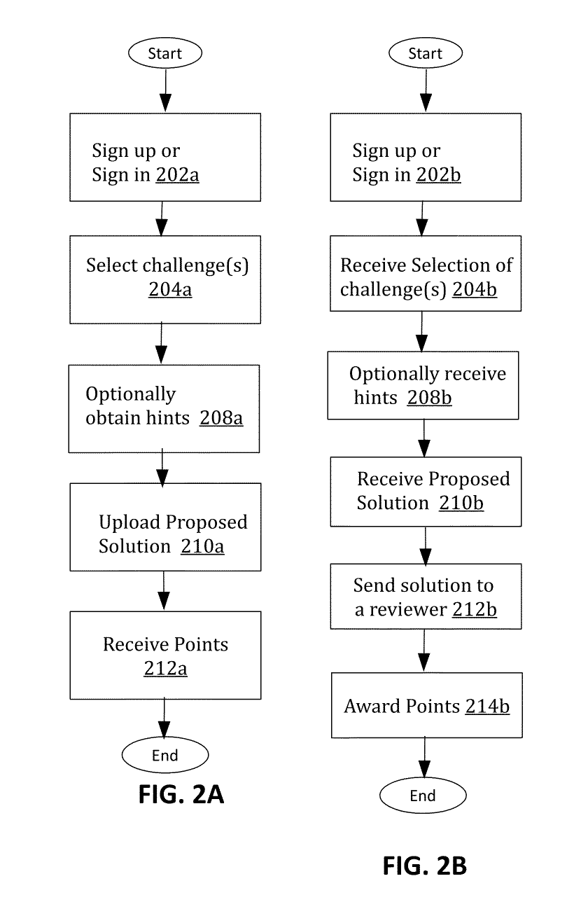

FIG. 2A is flowchart of an embodiment of a user-side method of gamifying personal development in an embodiment, showing how a user may sign up and play the challenge.

In step 202a, the user may sign up or sign in. For example and without limitation, signing up or signing in may include setting up the user's information in a database. Information such as name, email, job title, telephone number, cell number, address, and job interests may be taken. The user taking a challenge may be called a player and/or a “taker.”

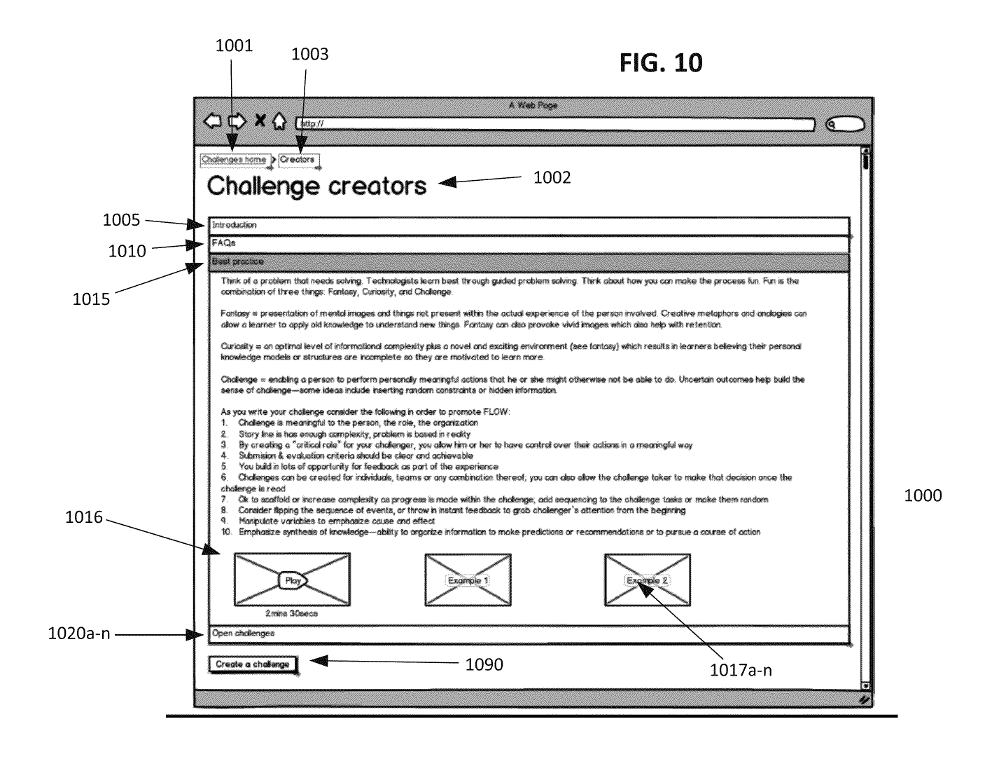

In step 204a, the player may select a challenge. By way of example and without limitation, selecting a challenge may include doing a search for a challenge of interest. Reviewing the difficulty, time limit, player number, topic, and hints to decide if the challenge is of interest and at the level the player wants, and activating a link for the challenge. The player may then choose a challenge by selecting the challenge and then the player may navigate to the page containing the challenge. Opening the challenge page may start the clock for the time limit. Alternatively, the page to which the player navigates, may contain information about the challenge that the player can review without starting the clock. The player may select a link or button for the challenge to start the clock. The method that starts the clock may be made clear to the player on the webpage. The challenge may involve the player viewing a problem. The problem associated with the challenge may be included in the plot, the title, topics, focus and/or tools. More information about the types of problems may be found in FIGS. 10 (see best practice information), 12 and 16.

In step 206a, the player may optionally obtain hints, if hints are available. Different challenges may include a different number of hints and rules related to how the hints affect the points or when the player may request a hint. When selecting the challenge, the player may be shown one or more hints that are available. The player may choose to request one or more hints while playing the challenge. Rules related to the hints can include the number of hints, when the hints appear (time after starting play), if the hints result in a reduction in points, etc.

In step 210a, the player may upload a proposed solution to the reviewer. When the player has completed the challenge, the player can submit the challenge. At that point, the challenge will be sent to a reviewer/evaluator to review the challenge.

In step 212a, the player may receive the review, points, and/or privileges, via the server. When the reviewer sends the review back to the player, the review may include the number of points the player has received for the challenge based on the review, the difficulty, the time used, etc. The number of points may be associated with certain privileges. For example, if the player receives a certain number of points in a given topic area, the player may then become the reviewer for challenges that relate to that topic area. In an embodiment, the number of points are computed by the server. The number of points may be computed based on an algorithm stored at the server. In an embodiment, the solution is also checked and scored by the server.

A player may take more than one challenge at one time, and the player may not need to finish one challenge before the player starts another challenge.

In an embodiment, each of the steps of method 200 is a distinct step. In at least one embodiment, although depicted as distinct steps in FIG. 2A, step 202a-212a may not be distinct steps. In other embodiments, method 200 may not have all of the above steps and/or may have other steps in addition to or instead of those listed above. The steps of method 200 may be performed in another order. Subsets of the steps listed above as part of method 200 may be used to form their own method.

FIG. 2B is flowchart of an embodiment of a server-side method of gamifying personal development in an embodiment, showing how a user may sign up and play the challenge.

In step 202b the server may receive sign up or sign in information from a user. For example and without limitation, signing up may include setting up the user's information in a database. Information such as name, email, job title, telephone number, cell number, address, and job interests may be provided.

In step 204b, in response to step 202b the server may send the challenge app and/or one or more pages of a GUI to the user machine. By way of example and without limitation, the app may include a GUI that allows a user to select a challenge from a list of challenges, such as a search engine. The GUI may include a selection of challenge options for the user. The server may receive a selection of a challenge from the user machine and, in response, may send the challenge(s) to the user machine.

In step 208b, the server may receive hints from the user machine related to the challenge.

In step 210b, the server may receive the user's proposed solution for the challenge.

In step 212b, the server may send the user's proposed solution to a reviewer. Alternatively, the server may review the proposed solution and assign points based on an algorithm or a formula. If a reviewer evaluates the solution, the server may receive the review from the reviewer machine.

In step 214b, as part of the review, one or more points may be provided to the player based on the review. The one or more points may be provided by the reviewer and/or the server based on a formula or algorithm. Alternatively, the number of points may be configured by the server using an algorithm. The awarding of the points may be subjective or non subjective. In at least one embodiment, the non-subjective awarding of the points is by an algorithm. The non-subjective algorithm may award points based on such parameters as complexity and/or difficulty of the challenge, hints used, time used, answers (correct or wrong), how many challenges the user has taken, how many times the user has taken the specific challenge, and/or how many challenges the user has created. After the review is complete, the server may send the review and points to the player.

In at least one embodiment, the user may play more than one challenge and/or create more than one challenge at one time, and the user may not need to finish one challenge (and be awarded points) in order to take another challenge.

In an embodiment, each of the steps of method 200b is a distinct step. In at least one embodiment, although depicted as distinct steps in FIG. 2B, step 202b-214b may not be distinct steps. In other embodiments, method 200b may not have all of the above steps and/or may have other steps in addition to or instead of those listed above. The steps of method 200b may be performed in another order. Subsets of the steps listed above as part of method 200b may be used to form their own method.

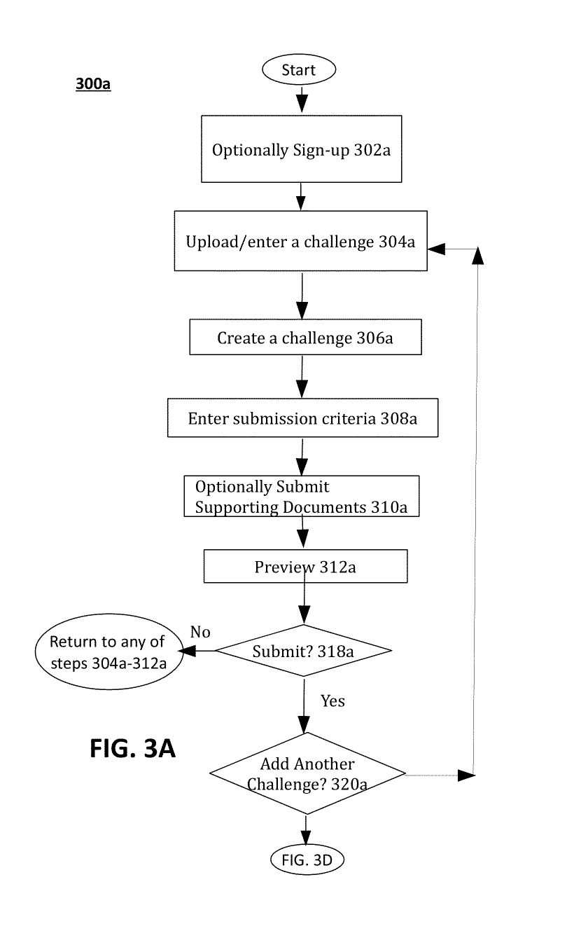

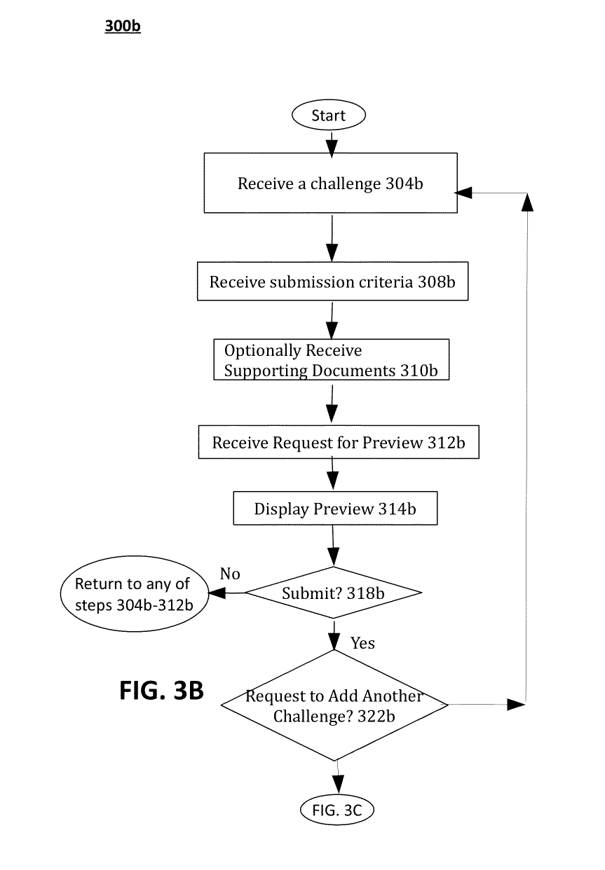

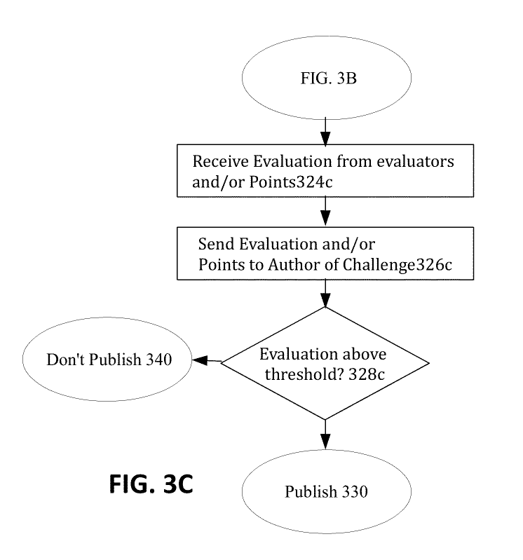

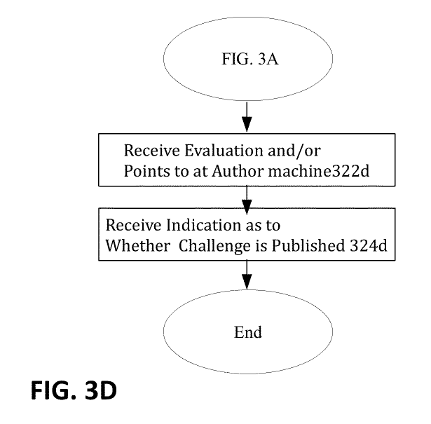

FIG. 3A is a flowchart of an embodiment of a user-side method of creating challenge. When the user is creating a challenge, the user may be called the “creator.”

In step 302a, the user may optionally sign up or sign in. For example and without limitation, signing up may include setting up the user's information in a database. Information such as name, email, job title, telephone number, cell number, address, and job interests may be provided by the user. Signing in may only require entering a username (or email) and a password. The user may have chosen the username and password during the sign up procedure. Alternatively, the server may choose a password and send the password to the user via email.

In step 304a, the user may choose to upload or enter a challenge becoming a creator. The user may choose to create a challenge on the home page.

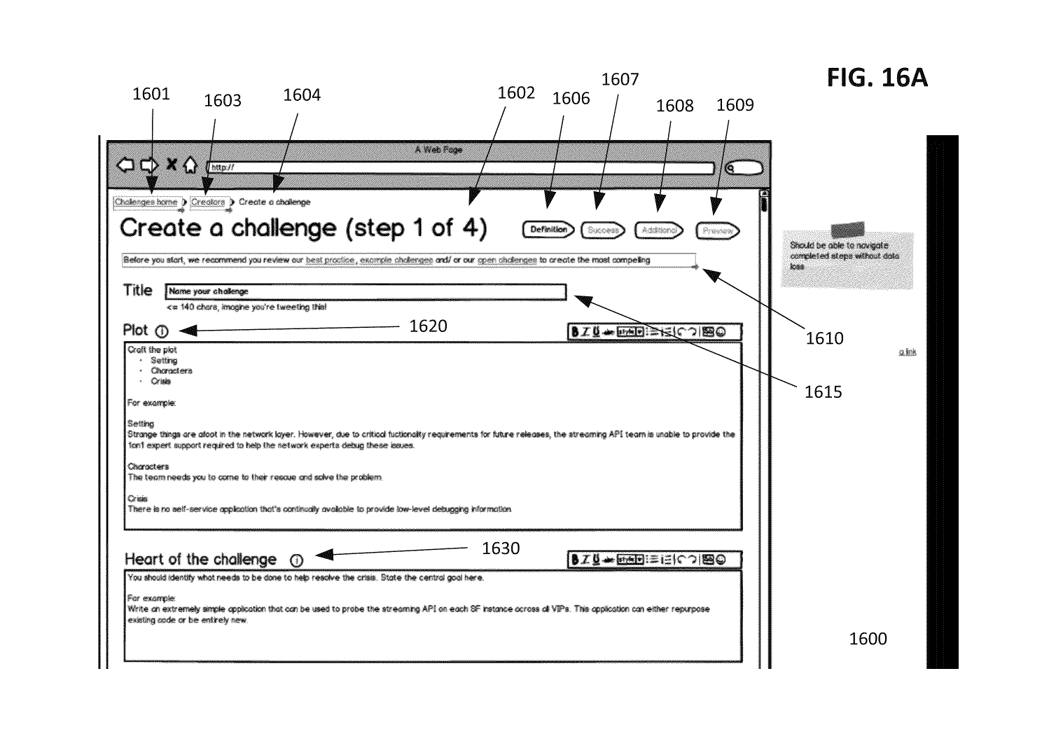

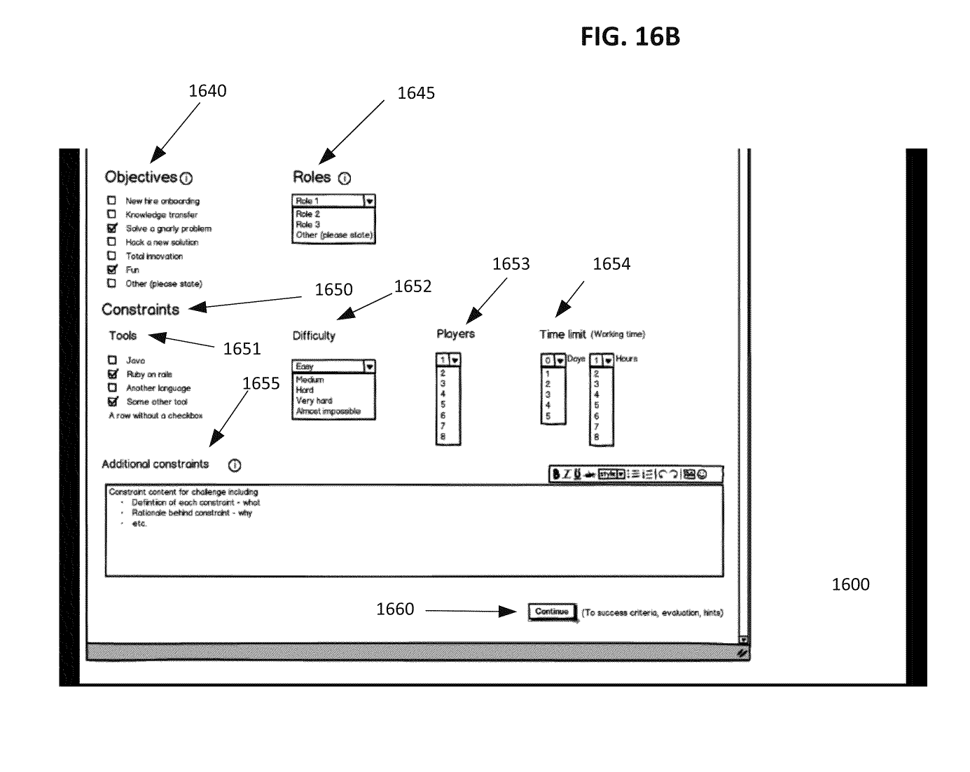

In step 306a, the creator may start to create a challenge. By way of example and without limitation, creating a challenge may include learning about creating a challenge, viewing tutorials, playing example challenges, and/or filling out challenge templates. The creator may receive a teaching rubric that allows a creator to learn how to create a challenge and/or walks the creator through the process of creating a challenge. The teaching rubric may include example challenges, tutorials, suggestions, and/or a template for the challenge. The creator can review the creation process and do some research on planning a challenge based on the information given in the teaching rubric. When the creator is ready to create a challenge, the rubric may contain detailed information that walks the creator through the process of creating a challenge. When creating the challenge, the creator may choose constraints, such as the difficulty, the time limit, hints, players, objectives, tools, roles and supporting documents. The process of creating a challenge may involve choosing the aspects of the challenge set out in FIG. 1. FIGS. 16-20 provide an example of webpages that contain a teaching rubric that can walk the user through the process of creating a challenge.

In step 308a, the creator may enter submission criteria for a winning solution. The criteria for a winning solution may include success criteria, the review and feedback process, and generic encouragement to counter fear of failure and/or public failure. The criteria may include the awarding of points. There may also be requirements that the submitted solution has to meet in order to be accepted. For example, the solution may be a single number, but the number may not be accepted unless it is written in scientific notation.

In step 310a, the creator may optionally submit supporting documents including an image. The image may be a meaningful image, photograph, icon, or drawing. The image may be made meaningful by choosing an image that gives a general idea of the topic, the plot, and/or the title. Other supporting documents may include a write-up, publications, and/or a videos.

In step 312a, the creator may preview and submit the finished challenge. The preview step may help ensure that there are no mistakes and/or problems associated with the creation of the challenge. After submission, the created challenge is sent to a reviewer/evaluator by the system.

In step 318a, the creator may decide whether to submit the finished challenge. If the creator decides not to submit the finished challenge, the creator can return to any of steps 304a-312a to edit or recreate a challenge.

If the creator decides to submit the finished challenge, in step 320a, the creator may decide whether to add another challenge. At this point, the creator may also choose to take a challenge rather than creating a challenge. The method continues in FIG. 3D.

In an embodiment, each of the steps of method 300a is a distinct step. In at least one embodiment, although depicted as distinct steps in FIG. 3A, step 302a-320a may not be distinct steps. In other embodiments, method 300a may not have all of the above steps and/or may have other steps in addition to or instead of those listed above. The steps of method 300a may be performed in another order. Subsets of the steps listed above as part of method 300a may be used to form their own method.

FIG. 3B is flowchart of an embodiment of a server-side method of gamifying personal development in an embodiment 300b, showing how a user may sign up and create the challenge.

In step 304b, the server receives the created challenge from the user machine. The challenge was created using a challenge creation app or template sent from the server after the server receives a request to create a challenge from a user's machine. The server sends the challenge creation app and/or GUI to the user's machine. The challenge creation app and/or GUI can include a teaching rubric (see FIG. 1 or more information about a teaching rubric). The process of creating a challenge may involve choosing the aspects of the challenge set out in FIG. 1. FIGS. 16-20 provide an example of webpages that contain a teaching rubric that can walk the user through the process of creating a challenge.

In step 308b, the server receives the submission criteria from the user machine, which may include criteria for the format in which to submit the solution and/or criteria for a solution to be acceptable.

In step 310b, the server receives the supporting documents and image from the user machine.

In step 312b, the server receives a request from the user machine for a preview of the challenge created by the user.

In step 314b, the server sends the display preview to the user for review. After the user previews the challenge, the user may decide whether to submit the challenge in step 318b.

If the user decides the challenge is not finished, the server receives a request to return to any of step 304b-312b to edit or create a different challenge.

If the user decides to submit the challenge, then in the server receives the completed challenge. In step 322b, the server checks to see if the user has decided to add another challenge.

In an embodiment, each of the steps of method 300b is a distinct step. In at least one embodiment, although depicted as distinct steps in FIG. 3B, step 304b-322b may not be distinct steps. In other embodiments, method 300b may not have all of the above steps and/or may have other steps in addition to or instead of those listed above. The steps of method 300b may be performed in another order. Subsets of the steps listed above as part of method 300b may be used to form their own method.

FIG. 3C is flowchart of an embodiment of a server-side method of gamifying personal development in an embodiment 300c (continued from FIG. 3B), showing how a user may sign up and create the challenge.

In FIG. 3C, step 324c, the server may receive an evaluation from the evaluator/reviewer machine and/or a rewarding of points. This may occur after the server sends the completed challenge to the reviewer/evaluator. In at least one embodiment, the reviewer decides on the points to be awarded based on the review, etc. In at least one embodiment, the server automatically computes the number of points based on a formula or algorithm. In at least one embodiment, a formula is used by the reviewer or the server to compute the number of points to be awarded to the user.

In step 326c, the server sends the review and points to the user machine (of the user that that authored the challenge).

In step 328c, the server checks to see if the points awarded are above a threshold.

In step 330c, if the points are above a threshold, the server publishes the challenge and the challenge is available to other users to play.

In step 340c, if the points are not above a threshold, the server does not publish the challenge and it is not available to other users to play. At this point, the user may decide whether to edit the challenge to try for more points and/or a better evaluation. Part of the game involves the challenger not increasing (or losing) creator status by not having the right pass/fail metric. To inculcate a sense of failure being “normal”, “expected” and part of any learning process, in an embodiment, a challenge creator would have to maintain a certain pass/fail ratio for challenges that the challenge creator creates. For example, the challenge creator may need to maintain a ratio of 66/33 passes to fails in order to garner creator points. As a result, a challenge creator may lose the ability to create more challenges if the challenge creator's score falls below a certain threshold.

In an embodiment, each of the steps of method 300c is a distinct step. In at least one embodiment, although depicted as distinct steps in FIG. 3C, step 324c-340c may not be distinct steps. In other embodiments, method 300c may not have all of the above steps and/or may have other steps in addition to or instead of those listed above. The steps of method 300c may be performed in another order. Subsets of the steps listed above as part of method 300c may be used to form their own method.

FIG. 3D is a flowchart of an embodiment of a user-side method of creating challenge. When the user is creating a challenge, the user may be called the “creator.” (continuing from FIG. 3A)

In FIG. 3D, step 322d, the creator may receive an evaluation and/or points at the creator's machine. The evaluation and/or points may come from the reviewer. The reviewer of the challenge that has been created may be a user, and/or a creator, and/or a company employee. The reviewer may be chosen based initially on whether the reviewer has created challenges, the reviewer's expertise, the number of points the reviewer has accumulated for specific topics related to the challenge, for example. The reviewer may also include the number of points that the player has received for the challenge and an explanation of why the specific number of points were awarded. Alternatively, the number of points may be awarded by the server using an algorithm, which may be configurable by allowing users with a high enough ranking to determine how many points the algorithm awards for particular achievements (the ranking may have been obtained as a result of the player receiving a certain number of points or more points than other players).

In step 324d, the creator may receive an indication as to whether the challenge is published. If the challenge is published, other user may play the challenge.

At any time during the process of FIGS. 3A and 3D, the creator may edit the challenge and/or add another challenge. The creator may not need to wait for the review or to finish the challenge before submitting one or more new challenges and/or taking a challenge.

In an embodiment, each of the steps of method 300d is a distinct step. In at least one embodiment, although depicted as distinct steps in FIG. 3D, steps 312d-316d may not be distinct steps. In other embodiments, method 300d may not have all of the above steps and/or may have other steps in addition to or instead of those listed above. The steps of method 300d may be performed in another order. Subsets of the steps listed above as part of method 300d may be used to form their own method.

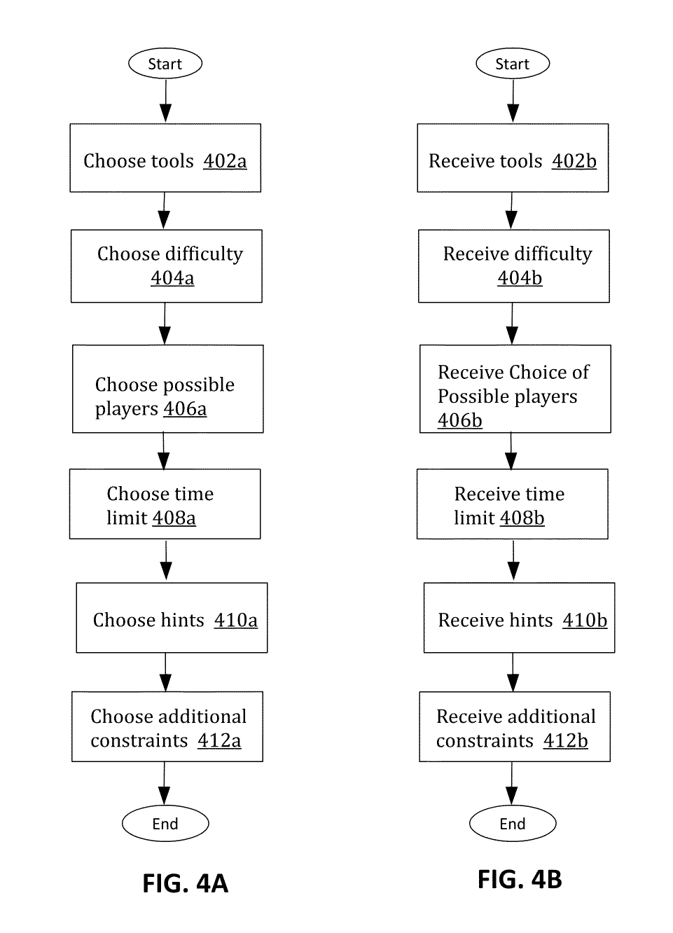

FIG. 4A is flowchart of an embodiment of a user-side method of details of creating a challenge (see step 306a of FIG. 3A) in a method of gamifying personal development, showing how a user may create a challenge.

In step 402a, the tools are chosen for the challenge. The tools can include any technical knowledge that is needed for the challenge. Examples of tools may include a workbench and/or debugger for developing a computer program An example will be discussed below, in conjunction with FIG. 16, of how the challenge creator can choose the tools (see the pulldown 1651).

In step 404a, the user may select a suggested difficulty at which to rank the challenge. The difficulty of the challenge may be based on a number of factors, including, but not limited to, the difficulty of the subject matter, the time limit, the number of hints, the expertise required to play the challenge, the technical ability required to take the challenge, etc. In at least one embodiment, input from players/users may be used to ascertain the difficulty of the challenge. The difficulty may be chosen from a list of levels (e.g., impossible, very hard, hard, medium hard, medium, medium easy and easy). Definitions for the difficulty levels may be included in a link. An example will be discussed below, in conjunction with FIG. 16, of how the challenge creator can choose the level of difficulty (see the pulldown 1652).

In step 406a, aspects related to the players are chosen for the challenge. The aspects can include the number of players, the number in a team (if a team is used), the type of players (based on expertise, career level, etc.), the level of the players, and/or the role of the players. An example will be discussed below, in conjunction with FIG. 16, of how the challenge creator can choose the number and the roles of the players (see the pulldowns 1645 and 1653). In an embodiment, players themselves may have leeway to work as a cohort or team on a challenge even without the challenge specifically calling for working as a team.

In step 408a, the time limit is chosen for the challenge. The time limit may be any amount of time that is believed to be reasonable by the business or company. FIG. 1 gives more detail about the time limit. An example will be discussed below, in conjunction with FIG. 16, of how the challenge creator can choose the time limit (see the pull downs for days and hours 1654).

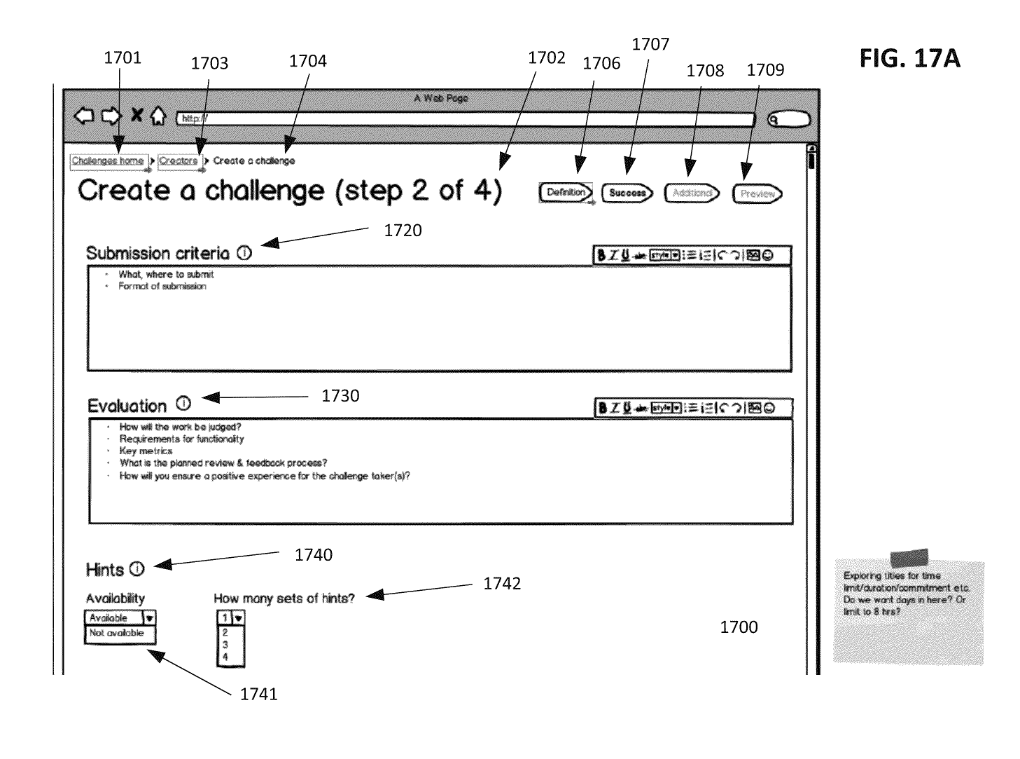

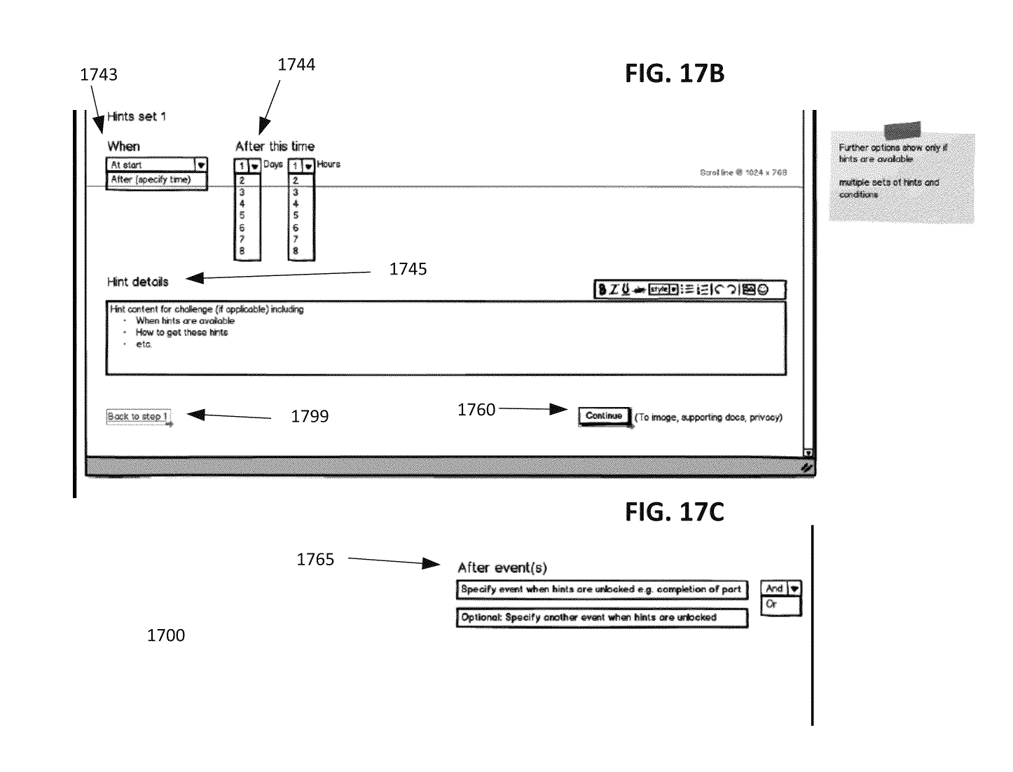

In step 410a, the hints are chosen for the challenge. The hints may be one type of constraint that may be made optional or mandatory. Hints 161 may help the user to finish the challenge more quickly, and/or more successfully. Hints is discussed in more detail in FIG. 1. An example will be discussed below, in conjunction with FIG. 17, of how the challenge creator can choose the hint criteria (see the pulldowns for availability 1741, how many sets of hints 1742, when 1743, after this time 1744, and hint details 1745).

In step 412a, the additional constraints are chosen for the challenge. Additional constraints can include any constraints not covered by time limit, difficulty, players, and hints. The additional constraints may be specific to a type of challenge (e.g., the number of steps that the user is allowed for solving the problem, the maximum number of lines of code that the player is allowed to include in a program, the language that the user is allowed to write a program in).

In an embodiment, each of the steps of method 400a is a distinct step. In at least one embodiment, although depicted as distinct steps in FIG. 4A, step 402a-412a may not be distinct steps. In other embodiments, method 400a may not have all of the above steps and/or may have other steps in addition to or instead of those listed above. The steps of method 400a may be performed in another order. Subsets of the steps listed above as part of method 400a may be used to form their own method.

FIG. 4B is flowchart of an embodiment of a server side method of details of creating a challenge (see step 306 of FIG. 3A) in a method of gamifying personal development in an embodiment, showing how a user may create a challenge.

In step 402b, the server receives tools from the user. The tools can include any technical knowledge that is needed for the challenge. Examples of tools may include a workbench and/or debugger for developing a computer program. An example will be discussed below, in conjunction with FIG. 16, how the challenge creator can choose the tools (see the pulldown 1651).

In step 404b, the server receives the difficulty chosen by the user representing how difficult the user intends the challenge to be. The difficulty of the challenge can include may be based on a number of factors, including but not limited to, the difficulty of the subject matter, the time limit, the number of hints, the expertise required to play the challenge, the technical ability required to take the challenge, etc. In at least one embodiment, input from players/users may be used to ascertain the difficulty of the challenge. The difficulty may be chosen from a list of levels (e.g., impossible, very hard, hard, medium hard, medium, medium easy and easy). Definitions for the difficulty levels may be included in a link. An example will be discussed below, in conjunction with FIG. 16, of how the challenge creator can choose the level of difficulty (see the pulldown 1652).

In step 406b, the server receives the choice of possible players and other aspects of players from the user. Aspects related to the players are chosen for the challenge. The aspects can include the number of players, the number in a team (if a team is used), the type of players (based on expertise, career level, etc.), the level of the players, and the role of the players. FIG. 16 gives an example of how the challenge creator can choose the number and the roles of the players (see the pulldowns 1645 and 1653).

In step 408b, the server receives the time limit from the user that determines how much time the player has to solve the challenge. The time limit may be any amount of time that is believed to be reasonable by the business or company. FIG. 1 gives more detail about the time limit. An example will be discussed below, in conjunction with FIG. 16, of how the challenge creator can choose the time limit (see the pull downs for days and hours 1654).

In step 410b, the server receives the hints. The hints may be constraints that may be made optional or mandatory. Hints 161 may help the user to finish the challenge more quickly, and/or more successfully. Hints are discussed in more detail in FIG. 1. An example will be discussed below, in conjunction with FIG. 17, of how the challenge creator can choose the hint criteria (see the pulldowns for availability 1741, how many sets of hints 1742, when 1743, after this time 1744, and hint details 1745).

In step 412b, the server receives the additional constraints. Additional constraints can include any constraints not covered by time limit, difficulty, players, and hints. The additional constraints may be specific to a type of challenge (e.g., the number of steps that the user is allowed for solving the problem, the maximum number of lines of code that the player is allowed to include in a program, the language that the user is allowed to write a program in).

In an embodiment, each of the steps of method 400b is a distinct step. In at least one embodiment, although depicted as distinct steps in FIG. 4B, step 402b-412b may not be distinct steps. In other embodiments, method 400b may not have all of the above steps and/or may have other steps in addition to or instead of those listed above. The steps of method 400b may be performed in another order. Subsets of the steps listed above as part of method 400b may be used to form their own method.

### Webpages

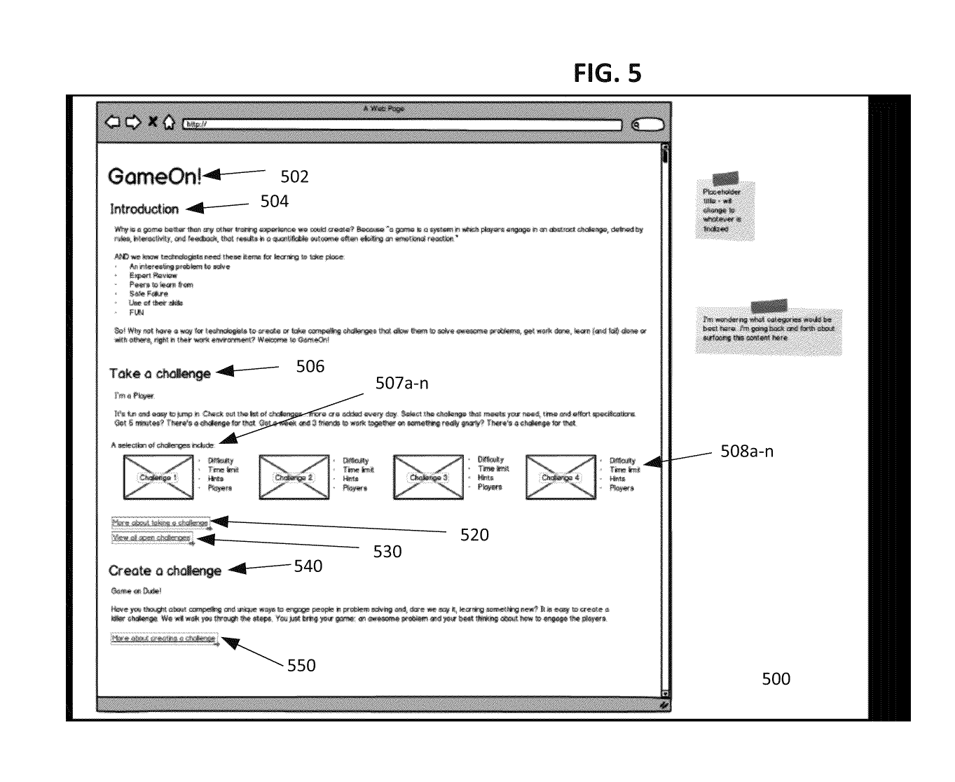

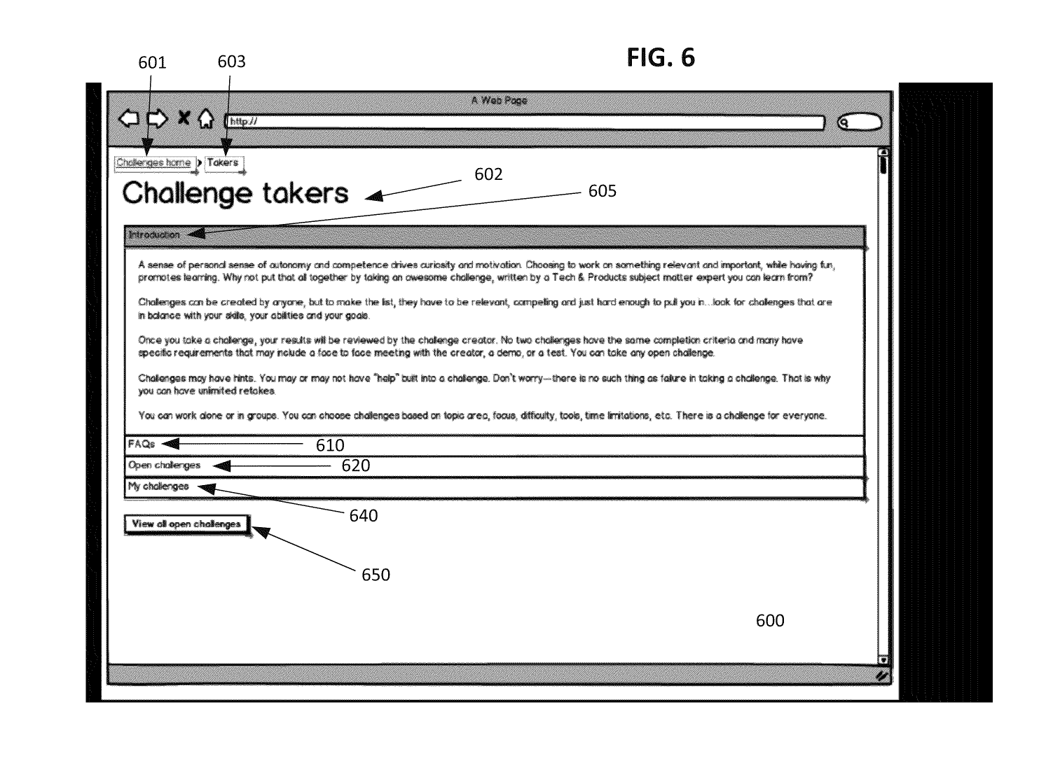

FIGS. 5-22 show screenshots of embodiments of webpages of a user interface for providing systems and methods for gamifying personal development. The webpages show methods of taking and/or creating challenges that teach aspects of personal development related to work-based skills. The methods provide a dynamic and interactive user-interface that teaches users and/or players aspects of work-based skills and/or methods of creating challenges. In the following descriptions, first a brief explanation of how FIGS. 5-22 relate to one another is presented, which is followed by a more detailed explanation of FIGS. 5-22. FIG. 5 shows a screenshot of an embodiment of a webpage that may be used to set up, take challenge(s) and create challenge(s) for gamifying personal development. FIGS. 6-8, 13-15 and 22 show screenshots showing embodiments of webpages used for taking challenges. FIGS. 9-12 and 16-21 show screenshots showing embodiments of webpages used for creating challenges.

FIG. 5 shows a screenshot of an example of an introductory webpage 500 of an embodiment of a method and system for gamifying personal development. Webpage 500 may include embodiments of webpage title 502, webpage explanation 504, take a challenge information 506, challenges 507a-n, take a challenge information link 520, view all open challenges link 530, create a challenge information 540, and create a challenge information link 550. In other embodiments, webpage 500 may not have all of the elements or components listed above and/or may have other elements or components instead of or in addition to those listed.

Introductory webpage 500 functions to introduce the idea of gamifying personal development and give the user a choice of taking a challenge or creating a challenge. Introductory webpage 500 contains links for the user to obtain more information and/or view open challenges. In at least one embodiment, introductory webpage 500 may function to sign a user up for a challenge site and/or sign a user onto a challenge site. Optionally, signing up or signing on may involve downloading an app.

Webpage title 502 functions to explain the purpose of the webpage. In FIG. 5, the webpage title is “Game On!” to convey to the user that webpage 500 provides information and links to play a game (e.g., challenge).

Webpage explanation 504 explains and/or introduces the function of the webpage in more detail. Webpage explanation 504 in FIG. 5 explains the page as an Introduction to the concept of taking a creating a challenge for teaching and/or training purposes. The page explains that a game is better than any other training experience because a game is a system in which players engage in an abstract challenge, defined by rules, interactivity, and feedback, that results in a quantifiable outcome often eliciting an emotional reaction. Further, that technologists need the following for learning to take place: an interesting problem to solve, expert review, peers to learn from, safe failure, use of the technologist's skills and fun. Therefore, the challenges are a way for technologists to create or take compelling challenges that allow the technologists to solve problems, get work done, learn (and fail) alone or with others, in the technologist's work environment.

Take a challenge information 506 functions to provide a short summary about taking a challenge. The information provided in FIG. 5 invites the player to check out the list of challenges (more are added every day), and select the challenge that meets the player's needs, time and effort specifications. The challenge may be as quick as 5 minutes or a week and may be taken with multiple (e.g., 3) friends to work together or alone.

Challenges 507a-n are tutorial examples of challenges for the user, which shows what the challenges look like. The challenges may be a selection that gives the user an idea of what is available. The challenges may be shown under a heading (e.g., “A selection of challenges include:”). The challenges may be shown with the title, an icon showing an image (relevant to the challenge), the difficulty, the time limit, the number of hints, players and any other information that may provide a quick summary of the challenge. In other embodiment, the challenge is shown with more or less information.

Take a challenge information link 520 functions to send the user to a page that gives more detailed information about how to take a challenge, including; rules, points, and constraints. Take a challenge information link 520 may also contain a tutorial about how to take a challenge.

View all open challenges link 530 functions to send the user to a page where the user may search all open challenges to find the challenge, or a type of challenge, the user may want to take. FIGS. 1, 2A and 2B provide more information about selection of challenges (see 112 in FIG. 1). The view all open challenges link 530 may send the user to a page where the user may activate a button to play the challenge. In FIG. 5, create a challenge information states; “Game on Dude! Have you thought about compelling and unique ways to engage people in problem solving and, dare we say it, learning something new? It is easy to create a killer challenge. We will walk you through the steps. You just bring your game: an awesome problem and your best thinking about how to engage the players.”

Create a challenge information 540 functions to provide a short summary about creating a challenge.

Create a challenge information link 550 may send the user to a page where the user may find more detailed information about how to create a challenge, including rules, points, other constraints and may include a tutorial on how to create a challenge.

FIG. 6 shows a screenshot of an example of a take a challenge webpage 600 of an embodiment of a method and system for gamifying personal development. Take a challenge webpage 600 may include embodiments of challenges home link 601, webpage title 602, takers link 603, challenge introduction 605, FAQs 610, open challenges link 620, my challenges link 640, and view all open challenges link 650. In other embodiments, webpage 600 may not have all of the elements or components listed above and/or may have other elements or components instead of or in addition to those listed.

In FIG. 6, the Introduction button has been selected opening a challenge introduction window. In at least one embodiments, selecting the introduction button sends the user to a page rather than a window being opened on the challenge introduction webpage.

Challenges home link 601, if selected, sends the user back to the challenges home page. FIG. 5 gives an example of a challenge home page.

Webpage title 602 provides an explanation of the function of the webpage. In FIG. 6, the webpage title 602 is “Challenge takers” and webpage title 602 shows the user that the user is on the challenge taker webpage as compared to the challenge creator webpage. The webpage title may also function to indicate to the user that the user is on the challenge taker's part of the system for gamifying and not the challenge creator's part of the system for gamifying.

Takers link 603 shows the user that the user is on a takers webpage (as opposed to being on a creators webpage). Since the system and method for gamifying personal development provides challenges for challenge takers and challenge creators, it is useful to make sure the user knows the user is on the correct page for the type of challenge the user wants.

Challenge introduction window 605 introduces concepts involved in taking a challenge to the user. In FIG. 6, challenge introduction states, “A sense of personal sense of autonomy and competence drives curiosity and motivation. Choosing to work on something relevant and important, while having fun, promotes learning. Why not put that all together by taking an awesome challenge, written by a Tech & Products subject matter expert you can learn from? Challenges may be created by anyone, but to make the list, they have to be relevant, compelling and just hard enough to pull you in . . . look for challenges that are in balance with your skills, your abilities and your goals. Once you take a challenge, your results will be reviewed by the challenge creator. No two challenges have the same completion criteria and many have specific requirement that may include a face to face meeting with the creator, a demo, or a test. You can take any open challenge. Challenges can have hints. You may or may not have “help” built into a challenge. Don't worry—there is no such thing as failure in taking a challenge. That is why you can have unlimited retakes. You can work alone or in groups. You can choose challenges based on topic area, focus difficulty, tools, time limitations, etc. There is a challenge for everyone.”

FAQs 610, when selected, provides a list of frequently asked questions pertaining to the taking of challenges.

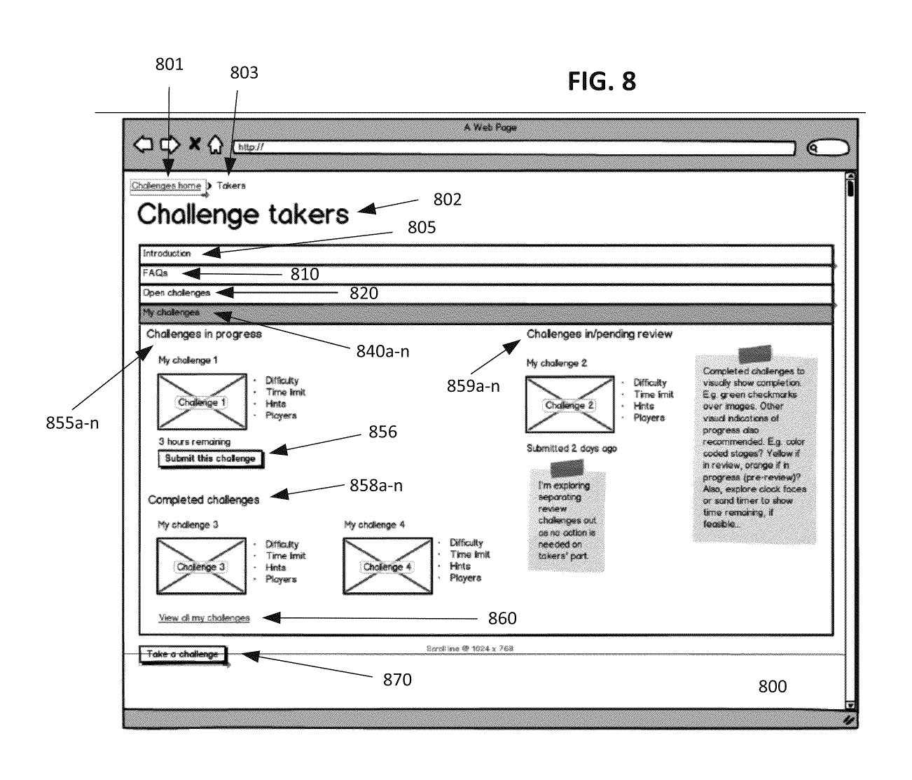

Open challenges link 620, when selected, sends the user to a page or to provide a window containing a selection of open challenges and an option to view all of the open challenges (or to do a search of all open challenges). An open challenge window will be discussed in conjunction with FIG. 8.

My challenges link 640 functions to send the user to a page or provide a window containing all of the challenges that the user is taking (e.g., current, past, and in-progress challenges). In at least one embodiment, the user's challenges can include challenges that the user is taking as well as challenges that the user is creating. In an embodiment as a result of selecting the my challenges link 640 all the statuses of ANY challenges taken: open, complete, failed, in creation, etc. may be viewable. The page that the user views as a result of selecting my challenges link 640 may be the player's personal dashboard for the game.

View all open challenges link 650 functions to send the user to a page or provide a window containing all of the open challenges.

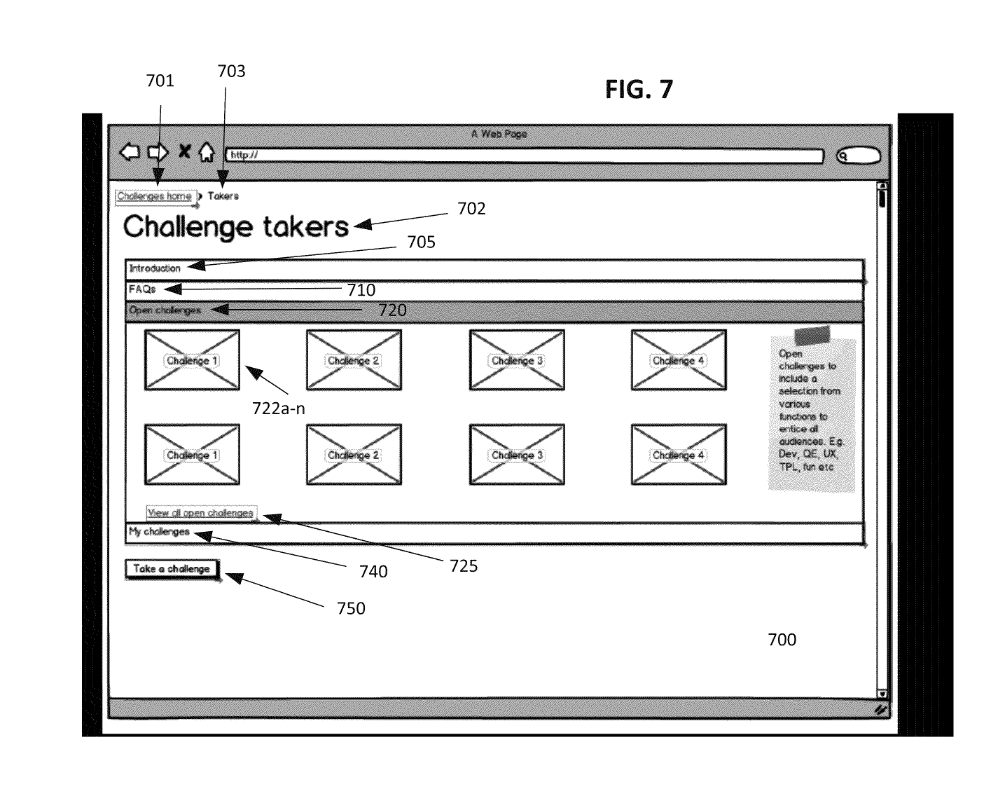

FIG. 7 shows an example of a screenshot of a challenge webpage 700 from FIG. 6 in which the open challenges link has been selected opening an open challenges window. Take a challenge webpage 700 may include embodiments of challenges home link 701, webpage title 702, takers link 703, challenge introduction 710, FAQs 720, open challenges link 720, challenges 722a-n, my challenges link 740, and take a challenge link 750. In other embodiments, webpage 700 may not have all of the elements or components listed above and/or may have other elements or components instead of or in addition to those listed.

Challenges home link 701, webpage title 702, takers link 703, challenge introduction 705, FAQs 710, my challenges link 740, and take a challenge link 750 are an embodiment of Challenges home link 601, webpage title 602, takers link 603, challenge introduction 605, FAQs 610, my challenges link 640, and take a challenge link 650, respectively, which were discussed in conjunction with FIG. 6.

Open challenges window 720 provides a selection of challenges that are open challenges to the user to choose. If the user does not like any of the open challenges shown in the selection, the user can choose a view all open challenges link 725 within the window to navigate to a page containing a search engine for finding other challenges. The open challenges 722a-n may be shown with the name, an image, and/or information about difficulty, time limit, players, hints, etc.

The user can choose one of the challenges in the selection by clicking on the envelope icon (the image) or the name of the challenge 722a-n or by clicking on the challenge and then selecting the take a challenge link 750. After selecting a challenge, the user may be navigated to a page containing the challenge, information about the challenge, and the challenge rules. The user may learn more details of the challenge. Then the user may choose to take the challenge, to cancel or to find a different challenge.

FIG. 8 shows an example of a screenshot of an embodiment of the take a challenge webpage 800 from FIG. 6 in which the my challenges link has been selected opening a my challenges window. Take a challenge webpage 800 may include embodiments of challenges home link 801, webpage title 802, takers link 803, challenge introduction 805, FAQs 810, open challenges link 820, my challenges window 840, challenges in progress 855a-n, challenge button 856, completed challenges 858a-n, challenges in/pending review 859a-n, view all my challenges link 860, and take a challenge link 870. In other embodiments, webpage 800 may not have all of the elements or components listed above and/or may have other elements or components instead of or in addition to those listed.

Challenges home link 801, webpage title 802, takers link 803, challenge introduction 805, FAQs 810, and open challenges link 820 are embodiments of challenges home link 601, webpage title 602, takers link 603, challenge introduction 605, FAQs 610, open challenge link 620, respectively, which were discussed in conjunction with FIG. 6. Take a challenge button 870 is an embodiment of take a challenge link 750, which was discussed in conjunction with FIG. 7.

In FIG. 8, my challenges window 840 has been opened, which shows the user's challenges arranged into the following groups: challenges in progress, challenges pending review, and challenges that are completed. Each challenge is shown below the relevant heading.

For example, challenge 1 with 3 hours remaining is shown under the heading “Challenges in Progress,” the challenges may be shown as lists or selections. The challenges may be represented on webpage 800 as icon, titles, images and/or in any way that allows the user to identify the challenge. The version shown in FIG. 8 represents the challenges as icons of an envelope with the challenge name inside the icon. However, the challenge name could be provided above the icon, under the icon and/or in a clear box to allow it to be more easily read. In an embodiment, the user may select on the icon and/or title to find out more about the challenge. In at least one embodiment, my challenges link 840 is a link that sends the user to a separate page containing the my challenges information. In FIG. 8, the my challenges link has been selected and is open or may be said to be expanded (whereas my challenges link 630 in FIG. 6 and my challenges link 740 in FIG. 7 are closed or may be said to be collapsed).

The challenges in progress 855a-n may include a list of any challenges that are still in progress. The user can see the amount of time remaining (e.g., 3 hours remaining) and the user can choose to reenter the challenge by clicking on the title (see “My challenge 1”) and/or the icon (see box). Other information, such as the difficulty, the time limit, the hints and the players may be displayed on webpage 800 next to the image as a quick summary of the challenge for the user.

Challenge button 856 functions to allow the user to submit the challenge. When selected, challenge button 856 causes the challenge to be selected. The challenges in progress 855a-n may include a submit this challenge button 856, which may be used, once the user decides that the challenge is ready to be submitted or once the user decides not to spend more time on the challenge for other reasons.

The completed challenges 858a-n may include any challenges that have been completed by the user. Selecting one of the icons of completed challenges 858a-n, opens a completed challenge for viewing, so that the player may may be

The challenges in/pending review 859a-n can include any of the user's challenges that are in the process of being reviewed or evaluated.

The view all my challenges link 860 functions to send the user to a page containing all of the user's challenges. The view all my challenges link 860 may be useful if the user's challenges cannot all fit within a my challenges window such as that shown in FIG. 8.

FIG. 9 shows an example of a screenshot of an embodiment of the create a challenge webpage 900 of a method and system for gamifying personal development. Create a challenge webpage 900 may include embodiments of challenges home link 901, webpage title 902, creators link 903, challenge creation introduction 905, FAQs 910, best practice link 915, open challenges link 920 and create a challenge link 990. In other embodiments, webpage 900 may not have all of the elements or components listed above and/or may have other elements or components instead of or in addition to those listed.

In FIG. 9, the Introduction button has been selected opening a create a challenge introduction window. The user can access FIG. 9 by choosing the more about creating a challenge link (see 550 in FIG. 5).

Challenges home link 901, when selected, sends the user back to the challenges home page. FIG. 5 gives an example of a challenge home page.

Webpage title 902 functions to provide an explanation of the function of the webpage. In FIG. 6, the webpage title 902 is “Challenge creators” to indicate to the user that the user is in the challenge creators part of the system for gamifying rather than the challenge takers part of the system for gamifying.

Creators link 903 shows the user that the user is on a challenge creator's webpage (as opposed to being on the challenge taker's webpage). Since the system and method for gamifying personal development provides challenges for challenge takers and challenge creators, it is may be beneficial to make sure the user knows the user is on the correct page for the type of challenge the user wants. The combination of challenges home link 901 and creators link 903 is the path that the user takes to arrive at challenge webpage 900. Stated differently, the combination of the combination of challenges home link 901 and creators link 903 form the URL or the last portion of the URL of challenge webpage 900.

Challenge creation introduction 905, when selected, displays to the user an introduction of the process of creating a challenge. In FIG. 9, the introduction states “If you want to create a challenge, most likely you are passionate about what knowledge you want to share with your challenge takers. Further, you are interested in gaming and how gaming may be used to develop people and get work done. There are different kinds of knowledge that may be effectively transferred using gaming: declarative knowledge, conceptual knowledge, rules-based knowledge, procedural knowledge, and soft skill knowledge. You are only limited by your imagination and your willingness to work through a simple challenge creation template.”

FAQs 910, when selected, displays a list of frequently asked questions pertaining to the creation of challenges.

Best practice link 915, when selected, provides an explanation of the best practices for creating a challenge. Examples of best practices will be discussed below in conjunction with FIG. 10 that are provided when the user chooses the best practices link 915.

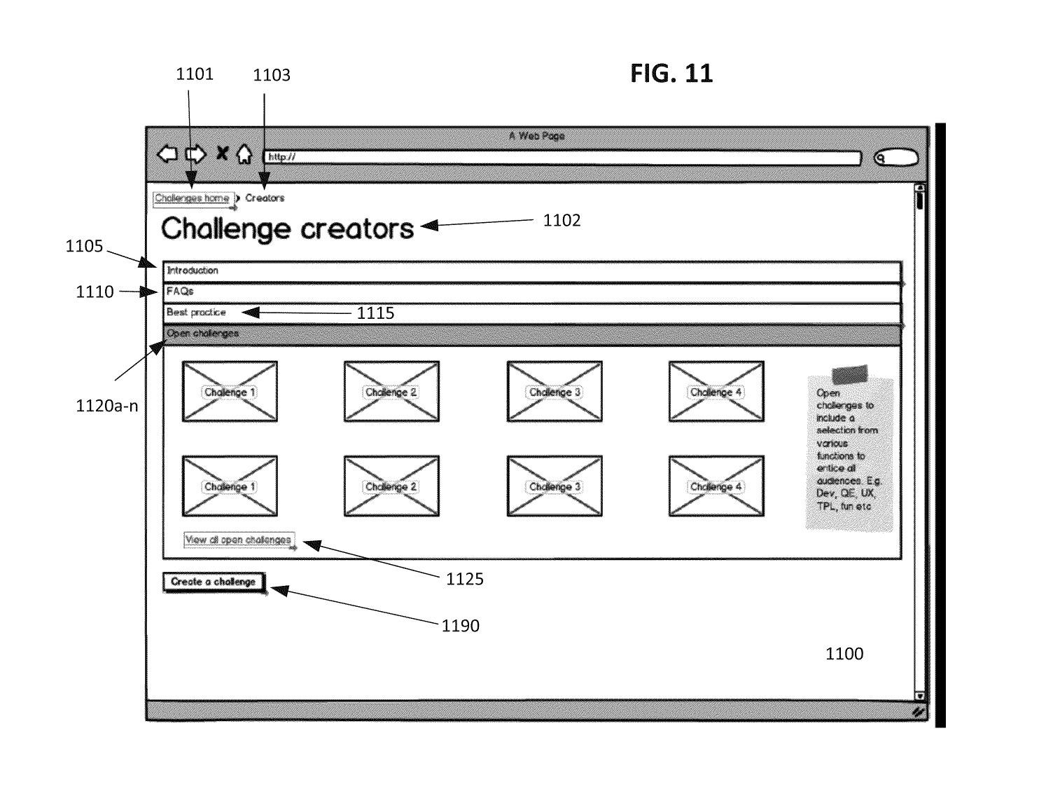

Open challenges link 920, when selected, provides a selection of various open challenges that may be viewed as example of challenges that may be created. An examples of an open challenge window that results upon selecting open challenge link 920 will be discussed below in conjunction with FIG. 11.

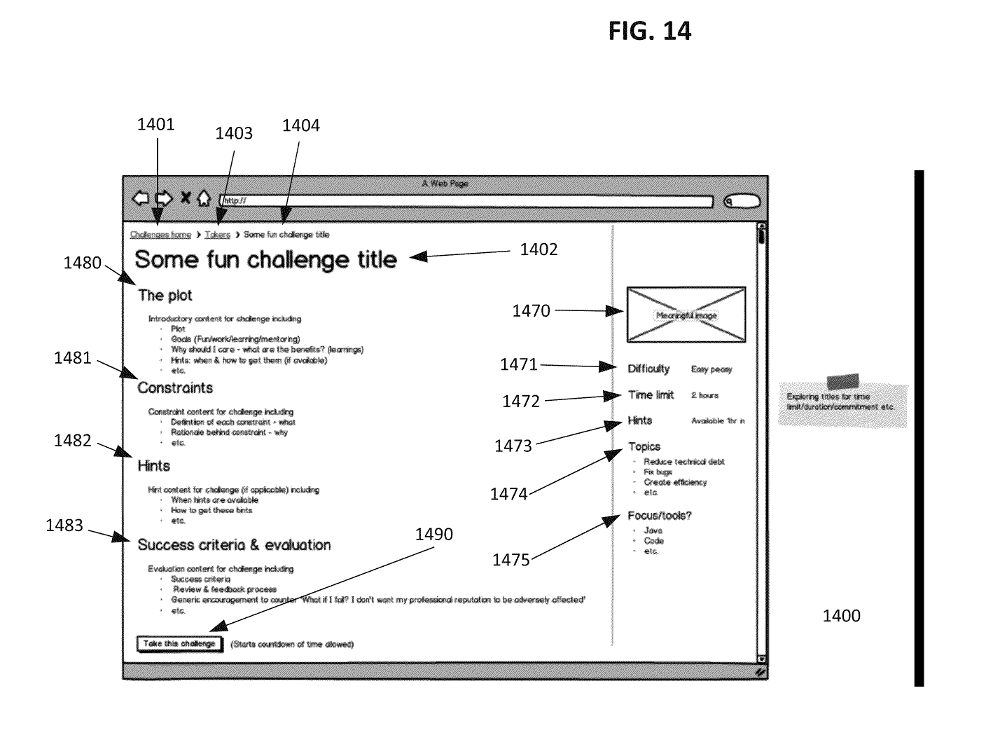

Create a challenge link 990, when selected, sends the user to a page where the user may begin the process of creating a challenge. An example of a create a challenge webpage will be discussed below in conjunction with FIG. 14 provides an example of a create a challenge webpage. In at least one embodiment, the create a challenge link 990 may take the user to one or more pages that teach the user how to create a challenge.

FIG. 10 shows a screenshot of an example of the create a challenge webpage 1000 of an embodiment of a method and system for gamifying personal development. Create a challenge webpage 1000 may include embodiments of challenges home link 1001, creators link 1002, webpage title 1002, challenge creation introduction 1005, FAQs 1010, best practice link 1015, open challenges link 1020a-n and create a challenge link 1090. In other embodiments, webpage 1000 may not have all of the elements or components listed above and/or may have other elements or components instead of or in addition to those listed.

Challenges home link 1001, creators link 1003, webpage title 1002, challenge creation introduction 1005, FAQs 1010, open challenges link 1020a-n and create a challenge link 1090 are embodiments of Challenges home link 901, creators link 903, webpage title 902, challenge creation introduction 905, FAQs 910, open challenges link 920a-n and create a challenge link 990, respectively, which were discussed in conjunction with FIG. 9.

In FIG. 10, the best practices button has been selected opening a best practices window 1015. The best practices window 1015 functions to introduce the idea of the best practices to be used when creating a challenge. The best practices may relate to any aspect of creating a challenge. The best practices window 1015 may also include a short audio and/or video containing instructions, a short audio and/or video containing a tutorial, a short audio and/or video containing an example of a challenge using best practices. The best practices window 1015 may also include one or more examples of challenges that use best practices. The examples may use a variety of work related challenges that teach personal development.

In an embodiment, the best practices window 1015 in FIG. 10 contains the following explanation of best practices: “Think of a problem that needs solving. Technologists learn best through guided problem solving. Think about how you can make the process fun. Fun is the combination of three things: Fantasy, Curiosity, and Challenge. Fantasy=presentation of mental images and things not present within the actual experience of the person involved. Creative metaphors and analogies can allow a learner to apply old knowledge to understand new things. Fantasy can also provide vivid images which also help with retention. Curiosity=an optimal level of informational complexity plus a novel and exciting environment (see fantasy) which results in learners believing their personal knowledge models or structures are incomplete so they are motivated to learn more. Challenge=enabling a person to perform personally meaningful actions that he or she might otherwise not be able to do. Uncertain outcomes help build the sense of challenge—some ideas include inserting random constraints or hidden information. As you write your challenge consider the following in order to promote FLOW: 1. Challenge is meaningful to the person, the role, the organization 2. Story line has enough complexity, problem is based in reality 3. By creating a “critical role” for your challenger, you allow him or her to have control over their actions in a meaningful way 4. Submission & evaluation criteria should be clear and achievable 5. You build in lots of opportunity for feedback as part of the experience 6. Challenges may be created for individuals, teams or an combination thereof; you can also allow the challenge taker to make that decision once the challenge is read 7. Ok to scaffold or increase complexity as progress is made within the challenge; add sequencing to the challenge tasks or make them random 8. Consider flipping the sequence of events, or throw in instant feedback to grab challenger's attention from the beginning 9. Manipulate variables to emphasize cause and effect 10. Emphasize synthesis of knowledge—ability to organize information to make predictions or recommendations or to pursue a course of action.”

FIG. 11 shows an example of a screenshot of a create a challenge webpage 1100 of an embodiment of a method and system for gamifying personal development. Create a challenge webpage 1100 may include embodiments of challenges home link 1101, creators link 1102, webpage title 1102, challenge creation introduction 1105, FAQs 1110, best practice link 1115, open challenges link 1120a-n, view all open challenges link 1125 and create a challenge link 1190. In other embodiments, webpage 1100 may not have all of the elements or components listed above and/or may have other elements or components instead of or in addition to those listed.

Challenges home link 1101, creators link 1103, webpage title 1102, challenge creation introduction 1105, FAQs 1110, best practices link 1115, open challenges link 1120a-n and create a challenge link 1190 are embodiments of challenges home link 901, creators link 903, webpage title 902, challenge creation introduction 905, FAQs 910, best practices link 915 and 1015, open challenges link 920a-n and create a challenge link 990, respectively, which were discussed in conjunction with FIG. 9.

Open challenges link 1120a-n, when selected, may provide a selection of challenges. Open challenges link 1120a-n may provide various types of challenges to entice the user to want to create a challenge. The selection may include the image and the title of the challenge. In at least one embodiment, the selection may include aspects of the challenge including the difficulty, time limit, hints, and players. The user may view one or more of the challenges to motivate the user to create a challenge.

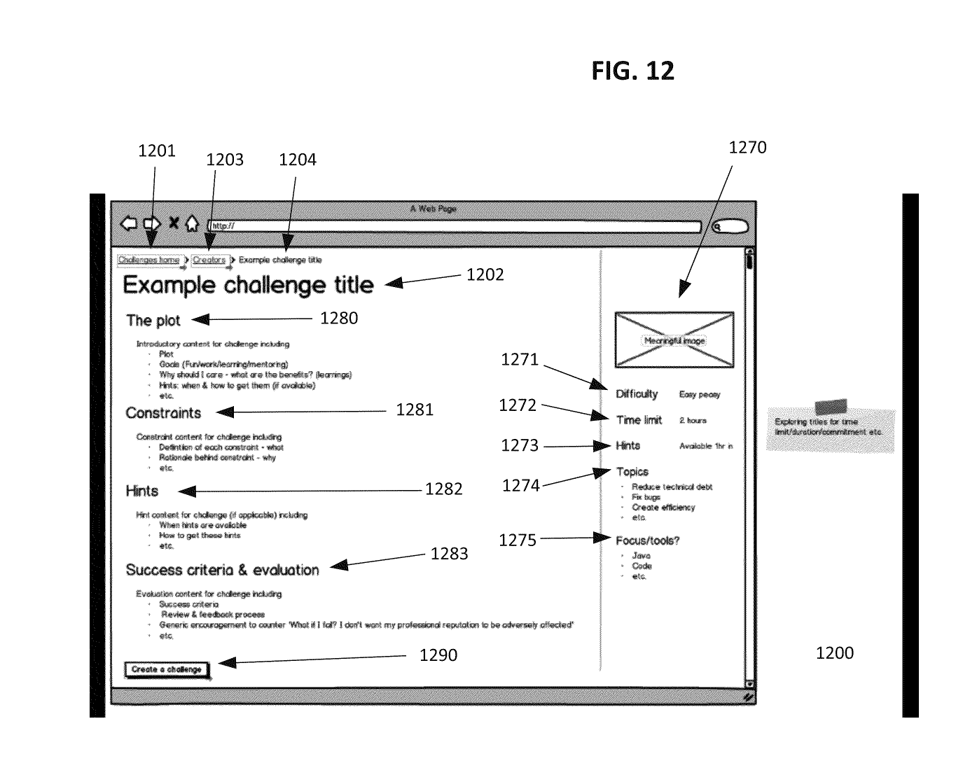

FIG. 12 shows a screenshot of an example of the challenge template webpage 1200 of an embodiment of a method and system for gamifying personal development after the user has chosen to view an example challenge. Challenge template webpage 1200 may include embodiments of challenges home link 1201, creators link 1203, webpage title 1202, example challenge title 1204, meaningful image 1270, difficulty 1271, time limit 1272, hints 1273, topics 1274, focus/tools 1275, the plot information 1280, constraints information 1281, hints information 1282, success criteria & evaluation information 1283 and create a challenge link 1290. In other embodiments, webpage 1200 may not have all of the elements or components listed above and/or may have other elements or components instead of or in addition to those listed.

Challenges home link 1201, creators link 1203, and create a challenge link 1290 are embodiments of as challenges home link 901, creators link 903, and create a challenge link 990, which were discussed in conjunction with FIG. 9.

Webpage title 1202 indicates the purpose of the webpage. Webpage title 1202 may be a short, succinct summary of the function of the webpage. Since the function of the challenge template webpage 1200 is to provide an example of a challenge to the challenge creator, webpage title 1202 may be any challenge title that has been created. In FIG. 12, webpage title 1202 is “Example challenge title,” because FIG. 12 is a template of what an example challenge webpage would show.

Example challenge title 1204 functions to provide the user with the title of the example challenge.

Meaningful image 1270 shows an image of the challenge that is meaningful to the challenge. The image may be shown in a rectangular shape or may be another shape such as an icon, a figure, a photograph, a drawing, etc. The image may be constrained by the number of colors, the number of pixels, the size, and/or the type of image (e.g., pornographic images may not be allowed).

Difficulty 1271 is discussed with reference to FIG. 1. In the example challenge, the difficulty is “easy peasy.”

Time limit 1272 is discussed with reference to FIG. 1. In the example challenge, the time limit is “2 hours.”

Hints 1273 is discussed with reference to FIG. 1. In the example challenge, the hints are available in 1 hr intervals (e.g., there are two hints).

Topics 1274 are topics to which the challenge is related, and functions to give the user an idea of what the challenge will be teaching them. One or more topics 1274 may be provided. In an embodiment, topics 1274 may be provided as a short sentence, a list or as bullet points. In FIG. 12, the topics are reduce technical debt, fix bugs, create efficiency, etc.

Focus/tools 1275 provides the user with an indication of what the challenge focus is or what tools the user will use (and therefore learn) in taking the challenge. In FIG. 12, the focus/tools are “Java, Code, and etc.”

The plot information 1280 provides the user with information about the plot and/or what is needed for a plot. Plot information 1280 in FIG. 12 is given as “Introductory content for challenge including: plot, goals (fun/work/learning/mentoring), why should I care—what are the benefits? (learning), hints: when & how to get them (if available), and etc.”

Constraints information 1281 was discussed above with reference to FIG. 1. In the example challenge, the constraint information is “Constraint content for challenge including • definition of each constraint—what • rationale behind constraint—why • etc.”

Hints information 1282 provides the user with information about the when and how of the hints. In FIG. 12, hint information 1282 is given as “Hint content for challenge (if applicable) including: when hints are available, how to get these hints, etc.”

Success criteria & evaluation information 1283 provides the user with an idea of how the challenge will be evaluated. Success criteria & evaluation information 1283 in FIG. 12 is: “Evaluation content for challenge including, success criteria, review & feedback process, generic encouragement to counter ‘what if I fail? I don't want my professional reputation to be adversely affected’, etc.”

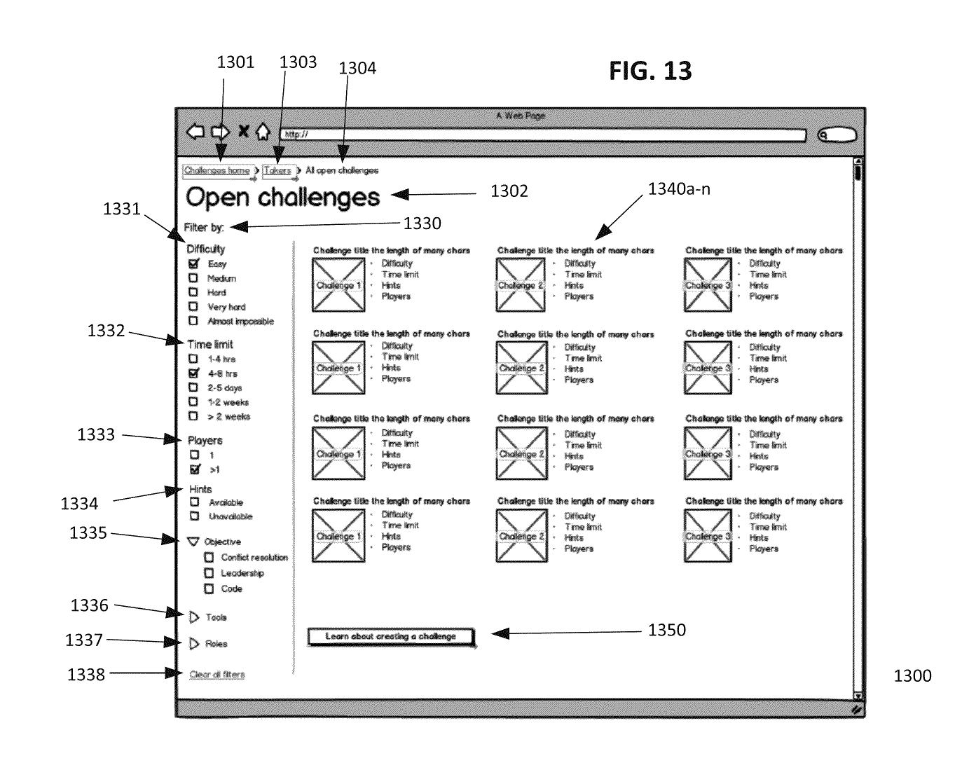

FIG. 13 shows an example of a screenshot of an all open challenge webpage 1300, which is used in a method and system for gamifying personal development after the user/taker has chosen to view all open challenges. All open challenges webpage 1300 may include embodiments of challenges home link 1301, webpage title 1302, takers link 1303, all open challenges title 1304, and filter by section 1330, which includes difficulty 1331, time limit 1332, players 1333, hints 1334, objective 1335, tools 1336, roles 1337 and clear all filters button 1338. All open challenges webpage 1300 may also include open challenges 1340a-n, and learn about creating a challenge link 1350. In other embodiments, all open challenges webpage 1300 may not have all of the elements or components listed above and/or may have other elements or components instead of or in addition to those listed.

Challenges home link 1301, and takers link 1303 are embodiment of challenges home link 801 and takers link 803 respectively, which is discussed in conjunction with FIG. 8.

Webpage title 1302 to provide an explanation of the function of the webpage. In FIG. 13, the webpage title 1302 is “Open challenges.” Open challenges are challenges that are available for challenge takers to take. Open challenges may be in the process of being taken by somebody, but it maybe that NO ONE has taken a particular open challenge yet.

All open challenges title 1304 shows the path where the open challenges page is located and provides the user with a confirmation that the user is on the all open challenges webpage.

Filter by section 1330 provides a list of filters that the user may select to find list of open challenges that the user may select. Filter by section 1330 functions to allow the user to select the challenges by choosing one or more criteria. The filters that the user may select may include, but are not limited to, difficulty 1331, time limit 1332, players 1333, hints 1334, objective 1335, tools 1336, and roles 1337. The choices for the filters may be provided under the heading “Filter” (as illustrated on FIG. 13) or in a pulldown menu. The user can select the level or choice of the filter that the user desires for the open challenge. The filters may be chosen by selecting a level or choice by clicking on the square (after clicking on the square a checkmark will appear in the square). For example, the user can choose a level of difficulty 1331 of easy, medium, hard, very hard, and almost impossible. Time limit 1332 include options that may be selected by the user find challenges that are within a particular range of time limits, which may be 1-4 hrs, 4-8 hrs, 2-5 days, 1-2 weeks, and >2 weeks. Players 1333 may include options that may be selected to filter the challenges to those that have a particular range of numbers of or a particular number of players, such as 1 or more than one. Hints 1334 may include options that may be selected to filter the challenges to those that have hints or those that do not have hints. Objective 1335 may include options for selecting a challenge according to whether that challenge meets a particular type of objective, such as conflict resolution, leadership, or code. Tools 1336 may be selected to choose a challenge according to the tools used for the challenge. Roles 1337 may used to choose the challenge according to the roles that are included in the challenge.

Clear all filters button 1338, when selected, clears whatever filters have been chosen. The clear all filters button 1338 may be used if the user wants to do a different search or to edit the search the user just performed.

Open challenges 1340a-n provides a selection of open challenges that have been created. The open challenges 1340a-n may be listed by the image, the title, the difficulty, the time limit, the hints, and the players. The user can click on the title or the image to take or view the challenge.

Learn about creating a challenge link 1350 functions to send the user to a webpage or webpages that allow the user to learn about creating a challenge.

FIG. 14 shows a screenshot of an example of a challenge template for the challenge entitled “Some fun challenge” webpage 1400 of an embodiment of a method and system for gamifying personal development after the user has chosen to take a challenge. The “Some fun challenge” webpage 1400 may include embodiments of challenges home link 1401, webpage title 1402, takers link 1403, some fun challenge title 1404, meaningful image 1470, difficulty 1471, time limit 1472, hints 1473, topics 1474, focus/tools 1475, the plot information 1480, constraints information 1481, hints information 1482, success criteria & evaluation information 1483, and create a challenge link 1490. In other embodiments, webpage 1400 may not have all of the elements or components listed above and/or may have other elements or components instead of or in addition to those listed.

The some fun challenge webpage 1400 is a specific challenge that the user has chosen from the open challenges page (see FIG. 13). In another embodiment, some fun challenges webpage 1400 may be titled “Fun Challenges.” When the user opens the chosen challenge (some fun challenge), the user may see a template page, such as that in FIG. 14, providing all of the parameters of the challenge. If the user still wants to take the challenge on the some fun challenge page, after reviewing the parameters, the user can activate the take this challenge button and the countdown (clock) will start for taking the challenge.

All of the elements of FIG. 14 (challenges home link 1401, webpage title 1402, takers link 1403, some fun challenge title 1404, meaningful image 1470, difficulty 1471, time limit 1472, hints 1473, topics 1474, focus/tools 1475, the plot information 1480, constraints information 1481, hints information 1482, success criteria & evaluation information 1483, and create a challenge link 1490) have been discussed with reference to FIG. 12 (See challenge template webpage 1200 may include embodiments of challenges home link 1201, creators webpage title 1202, takers link 1203, example challenge title 1204, meaningful image 1270, difficulty 1271, time limit 1272, hints 1273, topics 1274, focus/tools 1275, the plot information 1280, constraints information 1281, hints information 1282, success criteria & evaluation information 1283 and create a challenge link 1290), except the webpage title 1402 in FIG. 14 is “Some fun challenge title.”

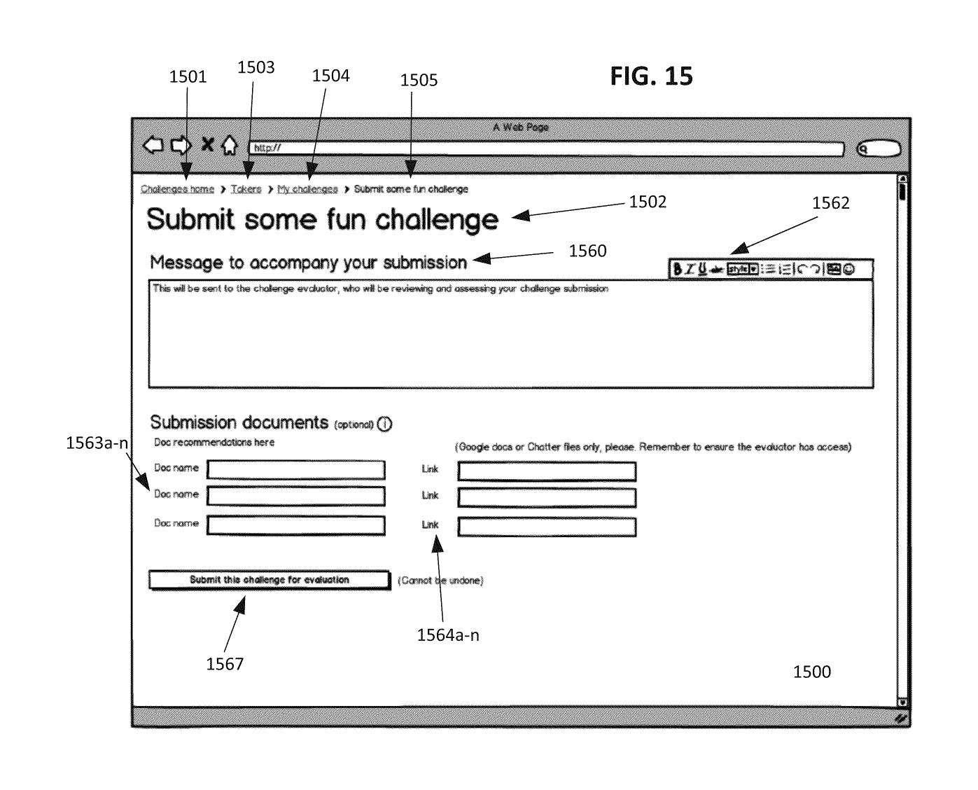

FIG. 15 shows a screenshot of an example of an embodiment of a submission webpage 1500. Submission webpage 1500 may include at least one embodiment of challenges home link 1501, webpage title 1502, takers link 1503, my challenges link 1504, submit some fun challenge title 1505, message field 1560, tools for message 1562, and submission document area 1563, which includes doc recommendations fields 1563a-n, link fields 1564a-n, and submit this challenge for evaluation button 1567. In other embodiments, submission webpage 1500 may not have all of the elements or components listed above and/or may have other elements or components instead of or in addition to those listed.

The user may see a page such as that shown in FIG. 15 when the user finishes the challenge entitled “Some fun challenge” (see FIG. 14). When the user finishes or the time limit is reached, the submit some fun challenge screen appears. The user can then finish the challenge by sending a message and/or a document or link.

Challenges home link 1501, webpage title 1502, are embodiments of challenges home link 901 and webpage title 902, respectively, which were discussed in FIG. 9, except that the title shown on FIG. 15 is “Submit some fun challenge.” Takers link 1503 is an embodiment of takers link 1403 discussed in conjunction with FIG. 14.

My challenges link 1504, when selected, sends the user to a page, or provides a window, containing all of the user's challenges (current, past, completed, and in progress). In at least one alternative embodiment, the user's challenges can include challenges that the user is taking as well as challenges that the user is creating.

Submit some fun challenge title 1505 is the current path of the webpage, which is for submitting a particular challenge that the user took.

Message field 1560 provides a field and tools for creating a message that may be sent with the submission of the solution of the challenge. One or more messages 1562 is the message that may accompany the submission of the challenge, which may be added via message field 1560. In FIG. 15, a default message initially appears in message to accompany submission field 1560, which reads “This will be sent to the challenge evaluator, who will be reviewing and assessing your submission.”

Submission document area 1563, when selected, optionally allow the user to submit documents with the challenge using the document name or a link. Depending on the type of challenge, additional documents may be necessary to complete the challenge.

Doc recommendations fields 1563a-n fields in which the user may optionally list names of documents that may be submitted as part of the solution to the challenge.

The link fields 1564a-n, when selected, open a window for searching for a link to a document that the user wants to submit with the challenge. The link field may include information about the size or type of link that may be accepted such as “(Google docs or Chatter files only, please. Remember to ensure the evaluator has access).”

The submit this challenge for evaluation button 1567, when selected, causes any information (messages, submission documents, etc.) added to or uploaded to the submission webpage to be submitted with the proposed solution to the challenge. The submit this challenge for evaluation button 1567 may include information about the submission such as “(Cannot be undone)”.

FIGS. 16-19 provide examples of screenshots of webpages that allow a challenge creator to create a challenge with a teaching rubric and/or a template. The webpages of FIGS. 16-19 provide a detailed template that helps the user create a challenge. The webpages of FIGS. 16-19 are numbered 1-4 and may be accessed by using the definition link (page 1), the success link (page 2), the additional link (page 3), and the preview link (page 4).

FIGS. 16A and 16B show a screenshot of an example of the definition webpage 1600 of an embodiment of a method and system for gamifying personal development.

In FIG. 16A, definition webpage 1600 may include embodiments of challenges home link 1601, webpage title 1602, creators link 1603, create a challenge title 1604, definition link 1606, success link 607, additional link 1608, preview link 1609, advice field 1610, title field 1615, plot field 1620, and heart of the challenge field 1630. In other embodiments, webpage 1600 may not have all of the elements or components listed above and/or may have other elements or components instead of or in addition to those listed.

Challenges home link 1601, webpage title 1602, and creators link 1603 have been discussed with reference to FIG. 12 (as challenges home link 1201, webpage title 1202, and creators link 1203) except that the webpage title in FIG. 16 is “Create a challenge (step 1 of 4).”

Create a challenge title 1604 informs the user of the path to the page that the user is currently on, and in FIG. 16A, the title of the page is “create a challenge.” The webpage is the beginning of the teaching rubric that walks a user through the process of creating a challenge. The user becomes a creator of a challenge, and the creator of a challenge is also a player of the game (as the challenge taker).

Definition link 1606 indicates that in the step that the user is currently on, the user is expected to define the challenge. Definition link 1606 is highlighted to indicate that the user may perform tasks related to the definition step, which is the first step of creating the game. By populating the fields on the page associated with the definition link 1606 (which is the webpage shown in FIGS. 16A and 16B), the creator can define the challenge. In the embodiment illustrated in FIG. 16A, the definitions link 1606 is at the top of the webpage, is shaped like a arrow and contains the word “definition” inside. The definition link 1606, which is currently selected, returns the user to the current page where the user can input information defining the challenge, including the title, plot, and heart of the challenge, which may explain some of the objectives, roles, and constraints of the challenge. Optionally, there may also be links to other pages for further defining the challenge.

Success link 1607, when selected brings the user to a webpage for defining the success criteria for the challenge. In an embodiment, it may not be possible to select success link 1607 until all of the required fields of definition webpage 1600 are filled in. In the embodiment of FIG. 16A the success link 1607 is not highlighted, because success link 1607 cannot be selected yet. The success criteria webpage will be discussed further in conjunction with FIGS. 17A and B. In FIG. 16A, the success link 1607 is at the top of the page, shaped like a arrow and contains the word “success” inside.

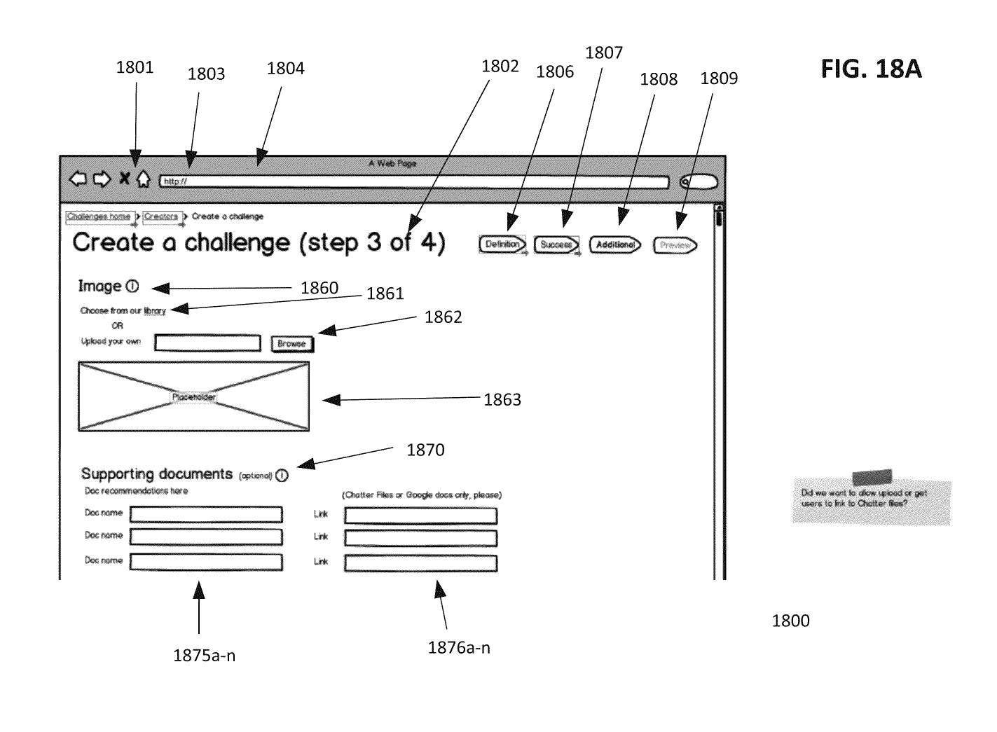

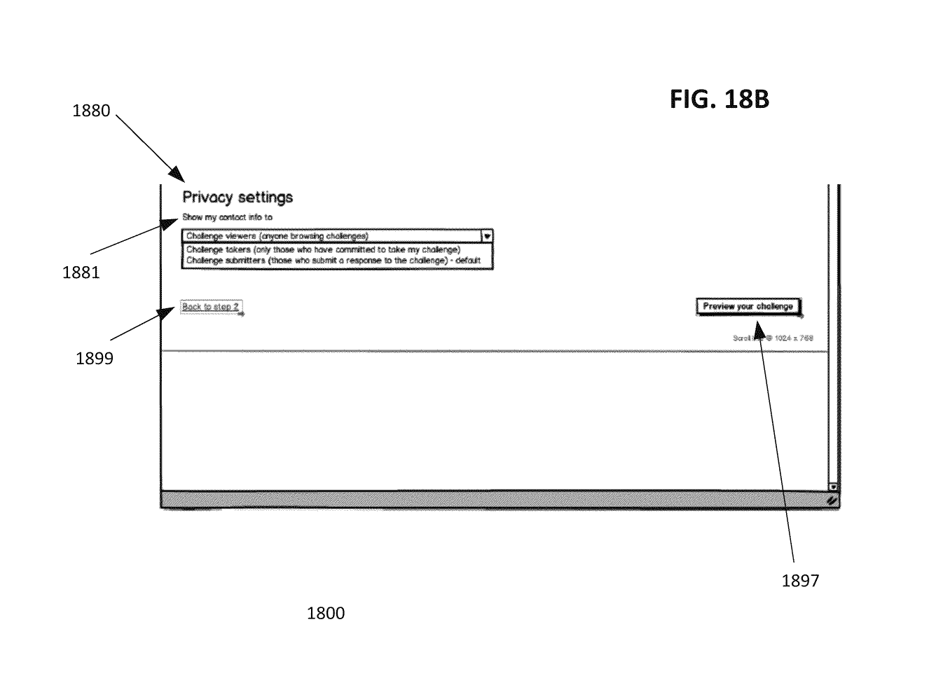

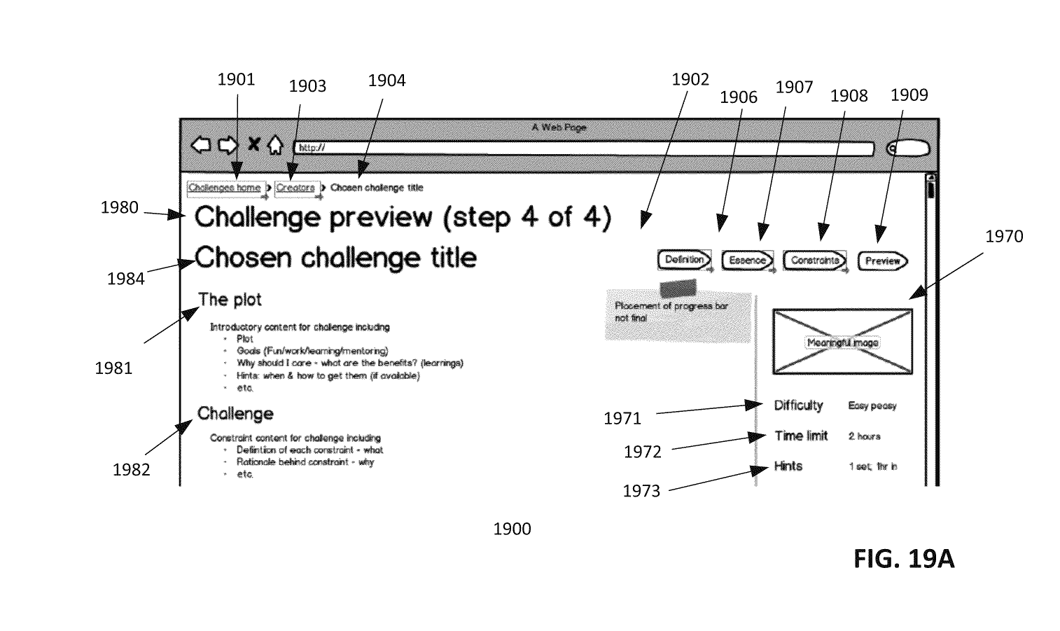

Additional link 1608, when selected, brings the creator to a webpage for providing other information about the challenge. In FIG. 16A, the additional link 1608 is shaped like an arrow and contains the word “additional” inside (the webpage for providing additional information will be discussed in conjunction with FIGS. 18A and B). In an embodiment, it may not be possible to select additional link 1608 until all of the required fields of definition webpage 1600 and the webpages associated with success link 1608 are filled in.

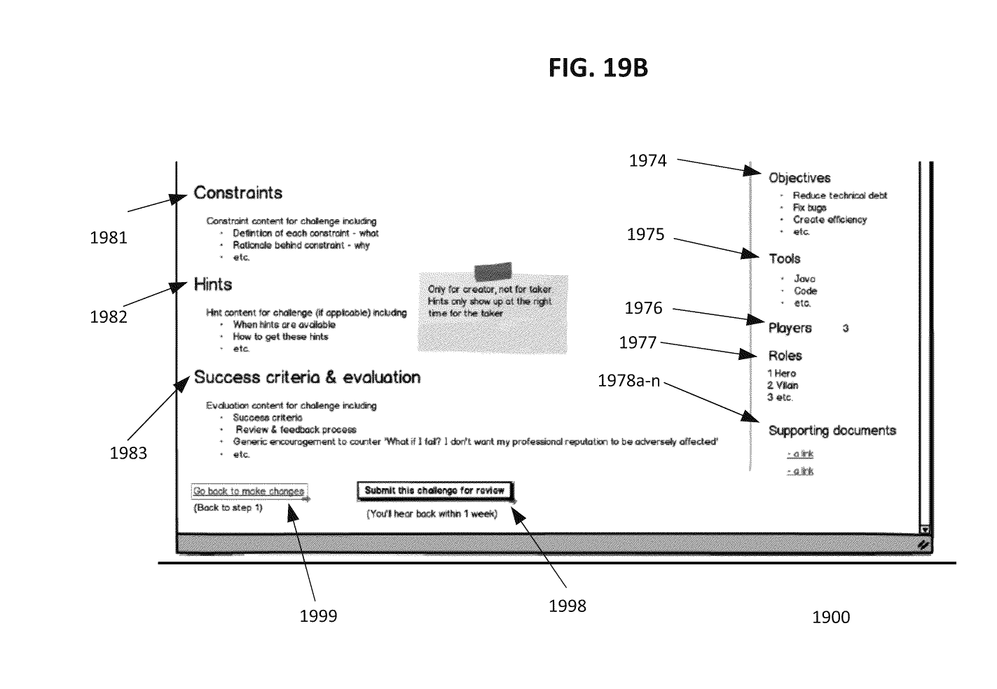

Preview link 1609, when elected, navigates the user to a page containing a preview of the challenge that the user created in the steps associated with definition link 1606, success link 1607, and additional link 1608, (preview link 1609 will be discussed further in conjunction with FIGS. 19A and B). In the embodiment of FIG. 16 A, the preview link 1609 is shaped like an arrow and contains the word “preview” inside.

The advice field 1610 provides the user with advice on how to begin the process of creating a challenge. The text of the advice may include links to other pages for further advice. In FIG. 16A, the advice field 1610 contains the suggestion “Before you start, we recommend you review our best practice, example challenges, and/or our open challenges to create the most compelling . . . ,” where “best practice,” “example challenges,” and “open challenges” are highlighted to indicate that these phrases are also selectable links that the user may use to access further information about best practices, to view open challenges, and examples of challenges. In other words, the user can access best practice, example challenges, and/or our open challenges pages by selecting the word or phrase in the advice field 1610.

Title field 1615 is a field into which the user may input a title for the challenge the user is creating. The field may provide additional information about title parameters such as “Name your challenge” and “<=140 chars, imagine you're tweeting this!” The user can input the title by clicking on the field and typing the title in using a keyboard.

The plot field 1620 is a field for entering information about the plot for the challenge. The creator can review guidelines about creating a plot if the creator chooses and then click in the field and input the information about the plot. For example, in FIG. 16A, the creator may be given guidelines about writing the plot (see, e.g., Craft the plot, setting, characters, and crisis). Then, the user is given an example of the plot (see e.g., Setting—Strange things are afoot in the network layer. However, due to critical functionality requirement for future releases, the streaming API team is unable to provide the 1 on 1 expert support required to help the network experts debug these issues. Characters—the team needs you to come to their rescue and solve the problem. and Crisis—There is no self-service application that's continually available to provide low-level debugging information.). The user/creator can input a plot using the keyboard and the format tools provided plot field 1620.

Heart of the challenge field 1630 is a field for entering information about the actual problem that needs to be solved. Heart of the challenge field 1630 may initially include guidance about how to explain the heart of the challenge to players. The creator can review the advice on how to create a problem to solve and then click on the heart of the challenge field 1630 to input the heart of the challenge for the creator's challenge. For example, in FIG. 16A, before the creator enters information into heart of the challenge field 1630, heart of the challenge field 1630 may include the text, “you should identify what needs to be done to help resolve the crisis. State the goal here.” An example is provided; “Write an extremely simple application that may be used to probe the streaming API on each SF instance across all VIPs. This application can either repurpose existing code or be entirely new.” The user can input the heart of the challenge using the keyboard and the drawing tools provided above the heart of the challenge field 1630. In title field 1615, plot field 1620, and heart of challenge field 1630 the user may be provided with tools for choosing the font, tools for underlining letters, tools for italicizing letters, tools for bolding letters, a spell checker, tools for creating bullets, tools for indenting paragraphs, tools for choosing line spacing, a tool for undoing a change, a tool for redoing a change, tools for adding icons, such as smiley faces, and/or other formatting or editing features.

In FIG. 16B, the lower portion of definition webpage 1600 may include embodiments of objectives list 1640, roles list 1645, and constraints 1650, including tools 1651, difficulty 1652, players 1653, time limit 1654, and additional constraints field 1651. The lower portion of definition webpage 1600 may also include a continue button 1660. In other embodiments, the lower portion of webpage 1600 may not have all of the elements or components listed above and/or may have other elements or components instead of or in addition to those listed.

The objectives list 1640 provides a choosable list of objectives that the creator can select for the challenge the creator is creating. In FIG. 16B, the creator can click on the box of the desired objective to select. When selected, a checkmark may appear in the box of the desired objective. The objectives listed in FIG. 16B include, new hire onboarding, knowledge transfer, solve a gnarly problem, hack a new solution, total innovation, fun, other (please state). If the user chooses “other,” a field appears in which the user can input other objectives. In other embodiments, there may be other objectives listed.

The roles list 1645 provides a list of roles that the creator can choose. In an embodiment, role list 1645 may include suggested roles and/or other roles. In an embodiment, the creator may edit the roles on role list 1645. For example, the roles may be different roles that players may adopt (e.g., leader, team member, mage, sorcerer, wizard, fairy, knight, hero, etc.). In an embodiment, each role has specific goals in the challenge.

Constraints 1650 provides a list on constraints that the user can specify when creating a challenge. Constraints 1560 may include tools 1651, difficulty 1652, players 1653, time limit 1654, and additional constraints field 1651. The constraints 1650 can include choosable boxes, pulldown menus, and/or fields to input-chosen constraints. In an embodiment, tools 1651 in FIG. 16B provide a choice of Java, Ruby on Rail, another language, some other tool and a row without a checkbox. The user can choose one or more of the boxes by clicking on the box chosen. When selected, a checkmark may appear in the box. The difficulty 1652 provides a box that the user can a pulldown menu to choose easy, medium, hard, very hard, and almost impossible. The players 1653 includes a pulldown menu with a long row of numbers which the user can choose for the number of players. The time limit 1654 (working time) includes a box for days and minutes. The user can choose the number of days and/or minutes from a long list by pulling down to select the desired time. The additional constraints 1651 may be a field with a format function. The user may input additional constraints into the field by using the keyboard and the format tools provided.

Continue button 1660, when selected, sends the user to page 2 of the create a challenge process. In an embodiment, next to continue button 1660, the legend, “(to success, criteria, evaluation, hints)” appears, which indicates that as a result of continuing the user is brought to webpages that relate to criteria of success, hints, and the manner of evaluation of the challenge solution. Alternatively, the user can choose the links at the top of the page to navigate to each of the desired pages (success, criteria, evaluation, hints).

FIGS. 17A and 17B show an example of the create a success webpage 1700 of an embodiment of a method and system for gamifying personal development.

In FIG. 17A, create a success webpage 1700 may include embodiments of challenges home link 1701, webpage title 1702, creators link 1703, create a challenge title 1704, definition link 1706, success link 1707, additional link 1708, preview link 1709, submission criteria 1720, evaluation 1730, hints 1740 including; availability 1741 and how many sets of hints 1742. In other embodiments, webpage 1700 may not have all of the elements or components listed above and/or may have other elements or components instead of or in addition to those listed.

Challenges home link 1701, webpage title 1702, creators link 1703, create a challenge title 1704, definition link 1706, success link 1707, additional link 1708, preview link 1709, and continue button 1760 are embodiments of as challenges home link 1601, webpage title 1602, creators link 1603, create a challenge title 1604, definition link 1606, success link 1607, additional link 1608, preview link 1609, and continue button 1660, which were discussed in conjunction with FIGS. 16A and B. In FIG. 17A, definition link 1706 and success link 1707 are highlighted, because the user may visit either page, but additional link 1708 and preview link 1709 are not highlighted, because the webpages associated with additional link 1708 and preview link 1709 are not available, yet.

Submission criteria 1720 is a field for entering submission criteria, which may include what, where to submit, and the format of the submission. The submission criteria 1720 may be included in a field and/or next to the field to help the user remember what to include. The submissions criteria 1720 field is provided with a format ruler that, with the help of a keyboard (for entering text), allow the user to input the submission criteria into the field.

Evaluation criteria 1730 is a field into which the creator may enter evaluation criteria. The field for evaluation criteria 1730 may initially include the text, “how will the work be judged? Requirements for functionality, key metrics, what is the planned review and feedback process? and How will you ensure a positive experience for the challenge taker(s)?” The evaluation criteria 1730 may be included in a field and/or next to the field to help the user remember what to include. The evaluation criteria 1730 field may be provided with a format ruler that, which with the help of a keyboard, allows the user to input the evaluation criteria (e.g., by entering text describing the criteria) into the field of the evaluation criteria 1730.

Hints 1740 provides an area in which the user can define the criteria with respect to hints.

The hint criteria include availability 1741 (available or not available). The availability can be chosen in a pulldown as available or not available. If the user chooses “not available” under the availability criteria 1741, the other fields need not be filled in.

How many sets of hints 1742 functions to provide the user with an area to specify the total number of hints/challenge. The hint number is provided as a pulldown in FIG. 17 allowing for up to 4 hints. If the creator chooses not to have hints (hints not available in the availability 1741 pulldown, then this field need not be filled in.

In FIG. 17B, create a success webpage 1700 may include embodiments of when 1743, and after this time 1744, hint details 1745, continue 1760 and back to step 1 link 1799. In other embodiments, webpage 1700 may not have all of the elements or components listed above and/or may have other elements or components instead of or in addition to those listed.

Hints 1740 in FIG. 17A provides an area in which the user can define the criteria for the hints. The hint criteria included in FIG. 17B, may include when 1743 (when the hints will become available—at the start or after a specified amount of time), after this time 1744 (days, weeks, minutes), and hint details 1745. The hint criteria 1740 in FIG. 17B may be provided as lists with choosable boxes and/or pulldowns. The hint details 1745 is a field into which details of the hints (e.g., the actual hints) may be input A format bar may be provided for formatting the content of the hint.

When 1743 allows the creator to decide when hints are available,

After this time 1744 work in concert with the when area to allow the creator to decide when hints are available.

Hint details 1745 allows the creator to include hint content for the challenge. More specifically, the hint content can include how to get the hints, will using hits reduce the points, etc.

Back to step 1 link 1799 when selected sends the user back to step 1 (definitions FIG. 16). See FIG. 16 for an example of the definitions page.

FIGS. 18A and B show a screenshot of an example of the additional webpage 1800 of an embodiment of a method and system for gamifying personal development.

In FIG. 18A, additional webpage 1800 may include embodiments of challenges home link 1801, webpage title 1802, creators link 1803, create a challenge title 1804, definition link 1806, success link 1807, additional link 1808, preview link 1809, Image 1860, choose from library button 1861, upload field 1862, placeholder 1863, supporting documents 1870 with doc name fields 1875a-n and doc link fields 1876a-n. In other embodiments, webpage 1800 may not have all of the elements or components listed above and/or may have other elements or components instead of or in addition to those listed.

Challenges home link 1801, webpage title 1802, creators link 1803, create a challenge title 1804, definition link 1806, success link 1807, additional link 1808, preview link 1809, and continue button 1860 have essentially the same description home link 1701, webpage title 1702, creators link 1703, create a challenge title 1704, definition link 1706, success link 1707, additional link 1708, preview link 1709, and continue button 1760, except the webpage title 1802 is “Create a challenge” (step 3 of 4). In FIG. 18A, definition link 1806, success link 1807, and additional link 1808 are highlighted, because the user may visit either page, but preview link 1809 is not highlighted, because the webpages associated with preview link 1809 is not available, yet.

Image 1860 may include an image, an icon, a photograph, and/or a drawing, for example, which may be chosen by the user as a visual indicator of the challenge. The image may be anything that is representative of the type of challenge, the plot, the topic, the heart of the challenge and/or constraints. The image may give an indication to a user viewing a number of challenges whether the user would like to take the challenge. The image may be chosen from a library of images provided in the application or may be uploaded. The image will appear in the placeholder when selected. There might be constraints on the image, such as the size, type, and quality.

Library button 1861, when selected, offers a library of images that the user may choose from. In other words, the image may be chosen from a library of images by selecting the choose from library button 1861. The library button 1861 may send the user to a page containing a library of images. The user can view the library and/or search the library and select an image. The image will automatically appear in a designated location on a webpage for taking the challenge that associated with the challenge when selected.

Upload field 1862, when selected, opens a page for finding and selecting the image. The image may be uploaded from another source using the upload field 1862. Once selected and/or uploaded, the image automatically appears in the placeholder.

The placeholder 1863 provides a place for the chosen image to be displayed. The user can use the placeholder 1863 to preview the image the user has selected and/or to see if the image will fit in the space.

The supporting documents 1870 includes tools for uploading documents for supporting the challenge. Doc name fields 1875a-n are fields into which the name of the selected documents may be entered and are automatically displaced. Doc link fields 1876a-n are links to the supporting documents, which support the challenge. The supporting documents 1870 may be included by searching for a document name (doc name fields 1875a-n) or by searching for a link (doc link fields 1876a-n).

In FIG. 18B, the lower portion of additional webpage 1800 may include embodiments of privacy settings 1880, show my contact info 1881, preview your challenge 1897, and back to step 2 button 1899. In other embodiments, webpage 1800 may not have all of the elements or components listed above and/or may have other elements or components instead of or in addition to those listed.

The privacy settings 1880 may be chosen by the user by accessing a pulldown menu and choosing one of the options on the pulldown menu. The privacy settings 1880 to whom and/or under what conditions private information about the challenge creator is displayed. The option may include, challenge viewers (anyone browsing challenges), challenge takers (only those who have committed to take my challenge), and challenge submitters (only those who submit a response to the challenge)—default. Show-my-contact-info pulldown 1881 is the pulldown menu for choosing the privacy settings.

Preview your challenge button 1897, when selected, sends the user to a page where the user can preview the challenge that the user has created.

Back to link 1899 has been discussed with reference to FIG. 17 (as back to step 1 link 1799) except that back to link 1899 is back to step 2 (not step 1)

FIGS. 19A and 19B show a screenshot of an example of the preview webpage 1900 of an embodiment of a method and system for gamifying personal development.

In FIG. 19A, preview webpage 1900 may include embodiments of challenges home link 1901, webpage title 1902, creators link 1903, chosen challenge title 1904 and 1905, definition link 1906, success link 1907, additional link 1908, preview link 1909, meaningful image 1970, difficulty 1971, time limit 1972, hints 1973, challenge preview 1980, the plot 1981, constraints 1982, and challenge 1983. In other embodiments, preview webpage 1900 may not have all of the elements or components listed above and/or may have other elements or components instead of or in addition to those listed.

In FIG. 19B, preview webpage 1900 may include embodiments of, continue button 1960, topics 1974, focus/tools 1975, and supporting documents 1978a-n, hints 1984, success criteria & evaluation 1986, submit this challenge for review button 1998, and back to make changes link 1999. In other embodiments, webpage 1900 may not have all of the elements or components listed above and/or may have other elements or components instead of or in addition to those listed.

The challenge preview page 1900 provides the user with a preview of the challenge the user has created. Even though in FIGS. 19A and 19B the challenge preview page 1900 is populated with general information, in practice, the user would see the specific information that the user has chosen.

Challenges home link 1901, webpage title 1902, creators link 1903, chosen challenge title 1904, definition link 1906, success link 1907, additional link 1908, preview link 1909, and go back to make changes button 1999 have been discussed with reference to FIG. 18 (as challenges home link 1801, webpage title 1802, creators link 1803, chosen challenge title 1804, definition link 1806, success link 1807, additional link 1808, preview link 1809, and go back to make changes button 1899), except the webpage title 1902 is “Challenge preview (step 4 of 4),” the create a challenge title 1804 from FIG. 18 is chosen challenge title 1904 in FIG. 19, and the back to step 2 link 1899 in FIG. 18 is go back to make changes link 1999 in FIG. 19.

The meaningful image 1970, difficulty 1971, time limit 1972, hints 1973, objectives 1974, focus/tools 1975, and supporting documents 1978a-n, while still showing general information in FIGS. 19A and 19B, would contain the specific information the user included for the challenge in FIGS. 16-18. Placeholder 1863 in FIG. 18 becomes the meaningful image 1970. The difficulty 1652 and time limit 1654 that was chosen by the challenge creator in FIG. 16 becomes the difficulty 1971 and time limit 1972 in FIG. 19. The hints 1740 that were chosen by the challenge creator in FIG. 17 becomes the hints 1973 in FIG. 19. The objectives 1640 and focus/tools 1651 that were chosen by the challenge creator in FIG. 16 become the objectives 1974 and focus/tools 1975 in FIG. 19. The supporting documents 1870 (if any) that were included by the challenge creator in FIG. 18 show up in FIG. 19 as the supporting documents 1978a-n in FIG. 19.

The function of the plot 1981, constraints 1982, hints 1984, and success criteria & evaluation 1986 remain the same as those shown in FIG. 12 (see function of the plot 1280, constraints 1281, hints 1282, success criteria & evaluation 1283 in FIG. 12, respectively) except that in the preview page 1900 these sections would be populated with the information the user has chosen for the challenge the user created in FIG. 16. Challenge 1983 lists information about the challenge, such as a description of the challenge. For example, as a result of selecting challenge 1983, the user may be brought to a webpage that explains that the description of the challenge should identify what needs to be done to resolve the crisis and the central goal of the challenge (where the crisis is explained in the description for the plot).

The review button 1998, when selected, submits the newly created challenge to the server to be sent to the reviewer. The user can review the challenge the user created and, when satisfied with the challenge the user created, can submit the challenge for review by selecting the review button 1998.

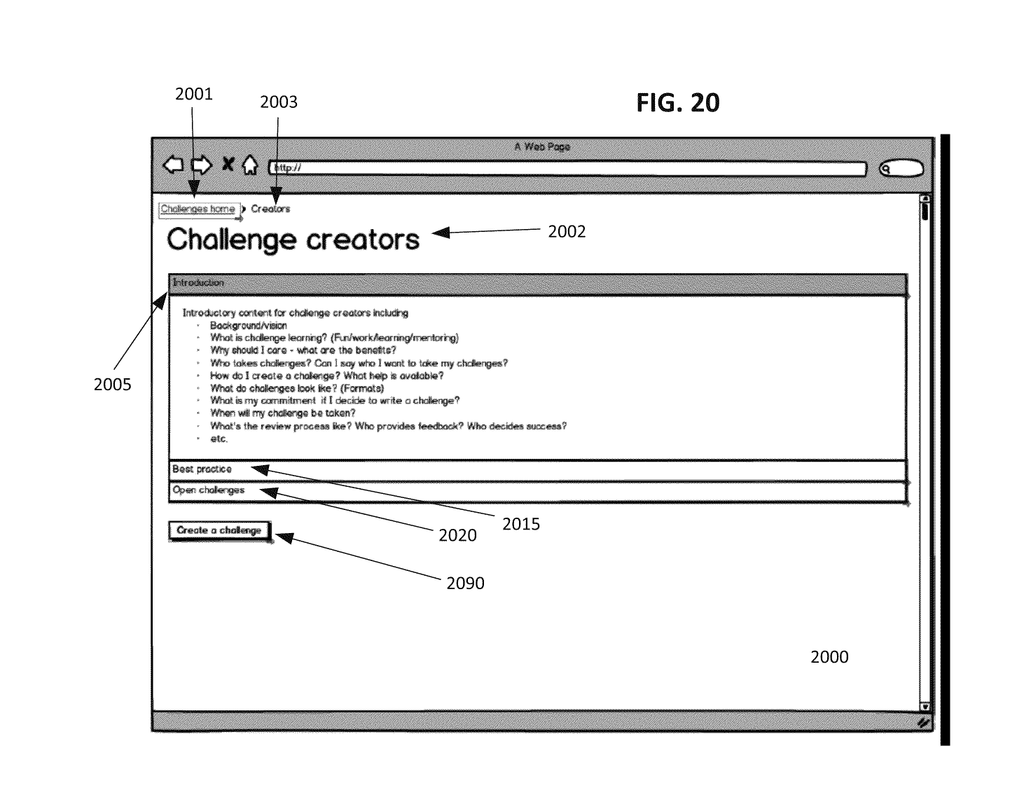

FIG. 20 shows a screenshot of an example of a creators webpage 2000 for an embodiment of a method and system for gamifying personal development for a user creating a challenge. Creators page 2000 may include embodiments of challenges home link 2001, webpage title 2002, creators title 2003, introduction 2005, best practice 2015, open challenges 2020, and create a challenge link 2090. In other embodiments, creators webpage 2000 may not have all of the elements or components listed above and/or may have other elements or components instead of or in addition to those listed.

FIG. 20 is another embodiment of FIG. 9. The explanations of the introduction are different from one another in FIGS. 9 and 20. Also FIG. 9 has an FAQ tab, whereas FIG. 20 does not.

Creators webpage 2000 may be accessed by selecting the creators link at the top of any of the creators webpages 2000. Challenges home link 2001, and webpage title 2002 have been discussed with reference to FIG. 9 (see challenges home link 901 and webpage title 902), except that the title shown on FIG. 20 is “Challenge creators.”

Best practice 2015, open challenges 2020, and create a challenge link 2090 are similar to or the same as best practice 915, open challenges 920, and create a challenge link 990, and have similar explanations.

Introduction 2005 provides the user, a challenge creator, a list of links for reading further information about creating a challenge and how to create a challenge. The list of links provide information about reason why to take a challenge, how to take a challenge, and some of the rules that apply to challenges, such as who can take a challenge and how success is determined. For example, in FIG. 20, the list of links may be “Introductory content for challenge creators including background/vision, what is challenge learning? (Fun/work/learning/mentoring), why should I care—what are the benefits?, who takes challenges? Can I say who I want to take my challenge/How do I create a challenge? What help is available?, What do challenges look like? (Formats), what is my commitment if I decide to write a challenge?, When will my challenge be taken?, What's the review process like? Who provides feedback? Who decides success? etc.” The user can activate any of the links to some answers for these questions by clicking on the question. In other embodiment, a button is provided next to the question that may act as a link to the webpage with the answers. In other embodiments, creators page 900 or creators page 20000 may be any combination of elements of FIGS. 9 and 20.

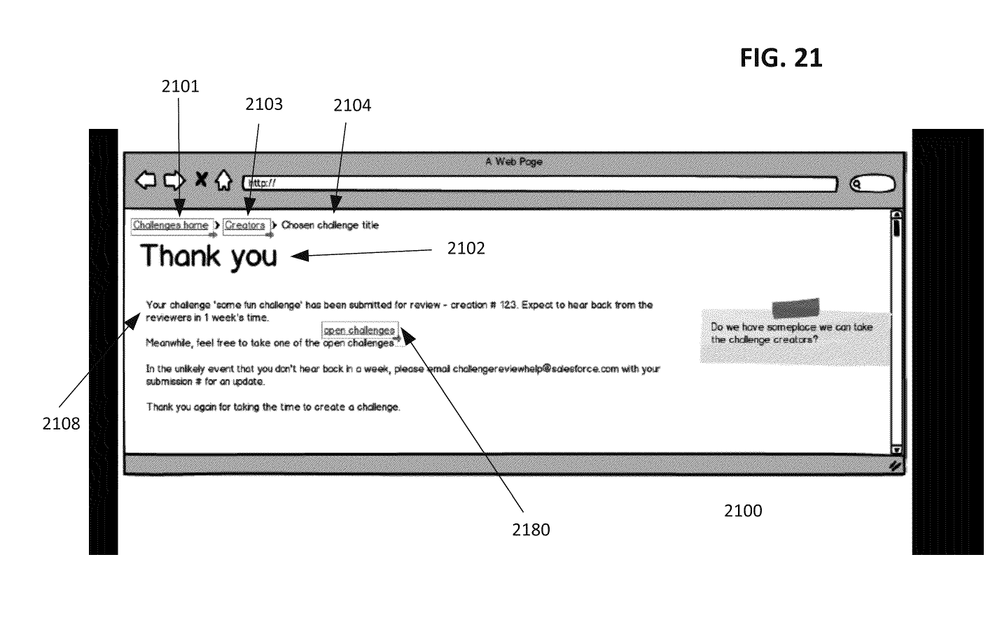

FIG. 21 shows an example of a thank you page 2100 for an embodiment of a method and system for gamifying personal development for a user creating a challenge. Thank you page 2100 may include embodiments of challenges home link 2101, webpage title 2002, creators link 2003, chosen challenge title 2104, submission information 2108, and open challenges link 2180. In other embodiments, webpage 2100 may not have all of the elements or components listed above and/or may have other elements or components instead of or in addition to those listed.

Thank you webpage 2100 may be accessed after (e.g., in response to) the challenge creator submits a challenge. Challenges home link 2101, and webpage title 2102 have been discussed with reference to FIG. 9 (as challenges home link 901 and webpage title 902), except that the title shown on FIG. 21 is “Thank you.”

Creators link 2103, when selected, sends the user back to the creators page (see FIG. 9 or 20) where the creator can get more information about challenges.

Chosen challenge title 2104 reminds the user of the title of the challenge the user has created and submitted.

Submission information 2108 explains to the user, which is a creator, the process of submission and what the user should expect. In FIG. 21, the information is “Your challenge ‘some fun challenge’ has been submitted for review—creation #123. Expect to hear back from the reviewers in 1 week's time. Meanwhile, feel free to take one of the open challenges . . . In the unlikely event that you don't hear back in a week, please email [the challenge reviewer] with your submission # for an update. Thank you again for taking the time to create a challenge.” The information may contain the actual challenge name chosen by the creator (instead of ‘some fun challenge’), the actual challenge number (instead of #123), an email for the reviewer, and an open challenges link 2180 that sends the user to a webpage having a selection of open challenges and/or a search engine for finding open challenges.

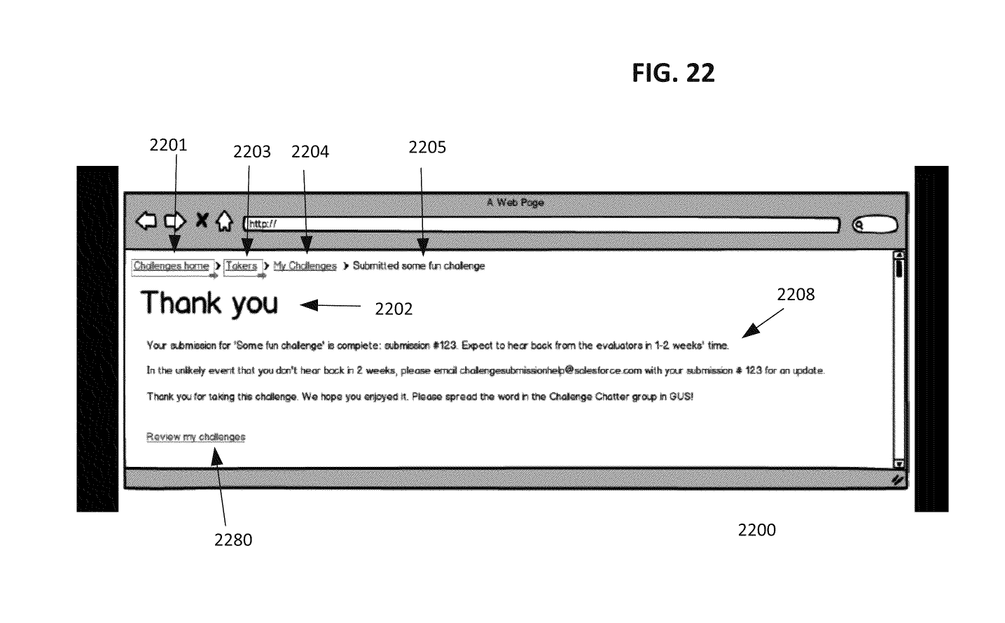

FIG. 22 shows a screenshot of an example of a thank you page 2200 for an embodiment of a method and system for gamifying personal development for a user taking a challenge. Thank you page 2200 may include embodiments of challenges home link 2201, webpage title 2202, takers link 2203, my challenges link 2204, Submitted some fun challenge title 2205, submission information 2208, and review my challenges link 2280. In other embodiments, webpage 2100 may not have all of the elements or components listed above and/or may have other elements or components instead of or in addition to those listed.

Thank you webpage 2200 may be accessed after the challenge taker submits a challenge. Thank you webpage 2200 differs from thank you webpage 2100 in that thank you webpage 2200 is displayed after submitting a proposed solution to a challenge, while thank you webpage 2100 is displayed after submitting a newly created challenge to determine whether to post the challenge for others to take. Challenges home link 2201, and webpage title 2202 are essentially the same as challenges home link 901 and webpage title 902), except that the title shown on FIG. 22 is “Thank you.”

Takers link 2203 sends the user back to the takers page (see FIG. 6) where the taker can get more information about challenges.

Chosen challenge title 2104 reminds the user of the title of the challenge the user has created and submitted.

Submission information 2208 explains to the user, which is a taker of a challenge, the process of submission and what the user should expect. In FIG. 22, the information is “Your submission for ‘some fun challenge’ is complete: submission #123. Expect to hear back from the evaluators in 1-2 weeks time. In the unlikely event that you don't hear back in 2 weeks, please email [challengesubmissionhelp] with your submission #123 for an update. Thank you for taking this challenge. We hope you enjoyed it. Please spread the word in the Challenge Chatter group in GUS!” The information may contain the actual challenge name (instead of ‘some fun challenge’), the actual challenge number (instead of #123), an email for someone to contact, and a review my challenges link 2280 that functions to send the user to a page having a selection of the user's challenges (see e.g., FIG. 18). The review my challenges link 2280 on the thank you page takes the person back to their personal dashboard. In an embodiment, all challenges, whether taken or created, and all the statuses of the challenges are available for the user to review.

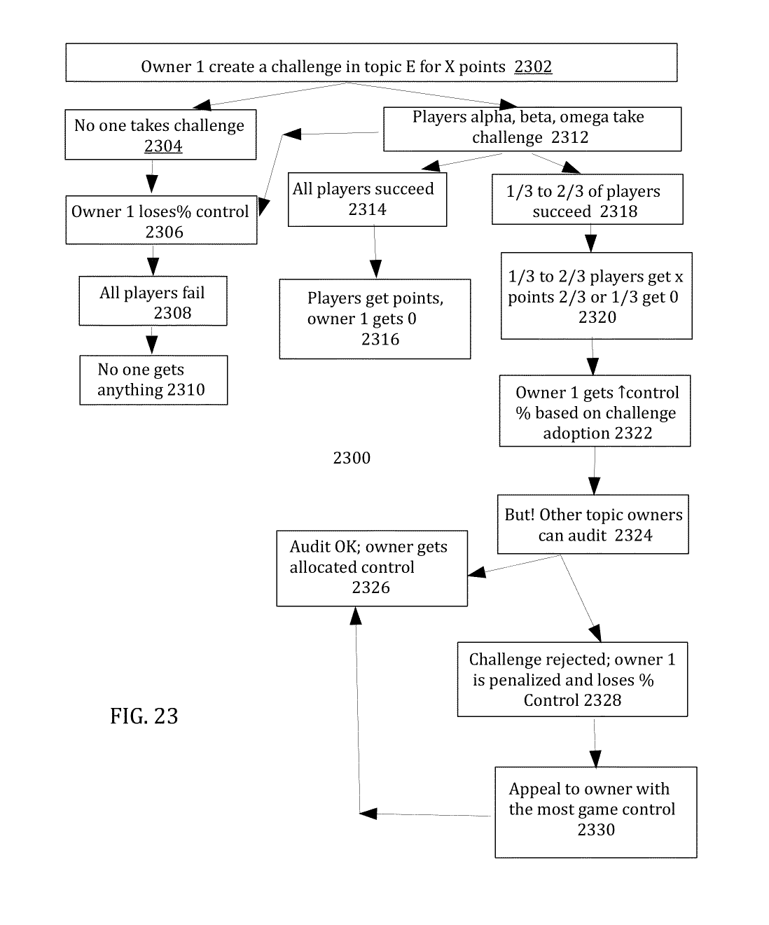

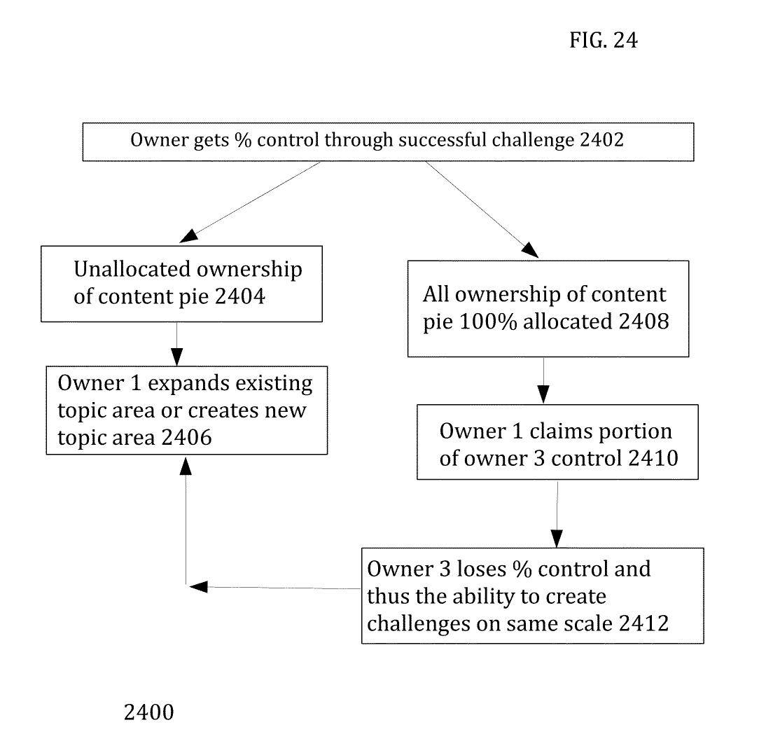

Currency Structure (FIG. 23 and FIG. 24)

FIGS. 23 and 24 provide flowcharts of embodiments of the currency structure for the system and method for gamifying personal development.

The currency structure may include the granting of points (creator points and/or taker points). Points may be accumulated in a particular area. By specific individuals each amassing points in particular topic areas, topic area leaders may be created. Each topic area leader may be granted a degree of control over the topic area in which that topic area leader has amassed points. The topic area leaders may attempt to contain and control the scope and importance of future topics. A community of experts may emerge. The experts may compete for content relevance and/or impact on the professional development of the larger organization and/or the range of offerings of challenges. The competition may include competing for a larger piece of the content pie. The economy may be a model for exchange of goods and services, includes currency financial products, and regulation (e.g., power). In the game, the currency is points. In an embodiment, the number of points is limited. Since the overall number of points is limited, the users/players/takers/creators are all competing for a share of the points. Alternatively, even if the number of points is not limited, players may still compete for the most points in different topic areas and/or the most points overall. The points may be obtained for completing challenges and writing successful challenges, for example, which may result in an increased % control over the limited field of topics. The exchange in the game may be learning (as a result of taking challenges, writing challenges, reviewing/evaluating challenges prior to the challenge being posted, and reviewing/evaluating proposed solutions to challenges) in exchange for power. The number of points assigned and ultimately won or lost in a challenge may be limited by the challenge creator's percentage of total power (e.g., % of the topic pie).

The regulations (the rules of the game) may include: 1. rules for successful challenge creation, 2. rules for successful challenge completion, 3. rules for converting successful challenge adoption into power, 4. rules for sustaining power, 5. rules for maximum distribution of power (e.g., 360 points in a pie), 6. rules for required failure rates for optimum points (e.g., successful challenges require some percentage of players/takers to fail), 7. rules for audit of challenges and results by topic leaders, 8. rules for challenge rejection (and results of that rejection), and 9. rules for exchange or transition of power based on ongoing adoption. The regulations of the game may be encoded in machine instructions that are implemented by a machine. The points awarded may be determined automatically and/or awarded via the machine. The privileges obtained by the points may be awarded by the machine, and enforced by the machine by restricting access to particular memory locations and/or files based on privileges awarded. For example, in an embodiment, only those with privileges for reviewing a particular type of solution or challenge are granted access to that challenge and/or to an interface for reviewing that type of solution and/or challenge.

FIG. 23 provides a flow diagram illustrating an example of a currency system for a system and method for gamifying personal development in an embodiment.

In FIG. 23, challenge creators (owners) lose power when no one chooses to take their challenges. This provides an economic lever for ensuring a supply of challenges that equals demand as well as continued update of game content. Challenges are successful when some players succeed while others fail. In other words, the challenge is not too easy or too difficult. This serves two purposes: 1. establishing learning as part of the game as learning in games is often accomplished through failure. Thus, a game everyone or no one can master is not a game and a challenge everyone or no one can master is not a challenge. 2. It provides another game economy lever by which the learning game organizers can determine the optimal amount of “failure” they would like to see from the players.

In step 2302, Owner 1 creates a challenge in topic E for X points. If no one takes owner 1's challenge, the method goes to step 2304. If someone (e.g., player alpha, beta or omega) takes the challenge, the method goes to step 2312.

In step 2304, no one takes the challenge. This has results for owner 1 (the challenge creator).

In step 2306, Owner 1 loses a % control of the topic pie. In an embodiment, the topic pie can contain all of the topics in the challenges as pieces of the topic pie. In an embodiment, a content pie only has 360 degrees. In an embodiment, a topic value may be assigned as the ratio of the number of degrees occupied by that topic to 360 degrees. A topic that occupies 90 degrees, would have a value of 90/360=0.25. The maximum topic value is 1, a topic value of 1 would be awarded to a topic that fills the entire topic pie. In an embodiment, a player may control more than one topic. A topic area may have many players with partial control. Power may be broad or deep. An algorithm may be used to figure out the percentage of control of a particular player.

In step 2308, all players fail the challenge. This is not a good result for the players or the creator (owner), because in step 2310, the players and the creator/owner do not receive any points.

In step 2312, players alpha, beta, omega take challenge (and method 2300 proceeds to step 2314 or 2318 or 2306 depending of number of players that succeed).

In step 2314, all players succeed. This is not a good result for the creator (owner), because in step 2316, the players get points, but the owner gets nothing (0).

In step 2318, ⅓ to ⅔ of players succeed in the challenge. This is the best example, because it means that the challenge was set up well—with the right amount of difficulty. This is the best result for the challenge creator/owner.

In step 2320, ⅓ to ⅔ of players get x points and ⅔ or ⅓ get nothing.

In step 2322, owner 1 gets more control % based on challenge adoption. Criteria that may go into deciding the amount of control include the number of players who chose the challenge, the difficulty, the number of previous challenges the owner has created and/or taken, etc. In at least one embodiment, there is an algorithm that takes one or more of the criteria into account in deciding the amount of points and/or % of control the owner and/or the players get.

In step 2324, another level of complication is added, because other topic owners can audit the result. If the audit result is ok, the method goes to step 2326 and the owner is allocated control. If the audit is not ok, the method goes to step 2328.

In step 2328, the challenge is rejected and owner 1 is penalized and loses % control. The percent control and/or points may be decided using an algorithm.

In step 2330, the creator appeals the audit to the owner with the most game control (go to 2326). If the decision is upheld, the creator of the challenge loses points.

In an embodiment, each of the steps of method 2300 is a distinct step. In at least one embodiment, although depicted as distinct steps in FIG. 23, step 2302-2330 may not be distinct steps. In other embodiments, method 2300 may not have all of the above steps and/or may have other steps in addition to or instead of those listed above. The steps of method 2300 may be performed in another order. Subsets of the steps listed above as part of method 2300 may be used to form their own method.

FIG. 24 is a flow diagram illustrating a currency system for a system and method for gamifying personal development in an embodiment. FIG. 24 provides a method of exchange of control for winning, claiming, or transferring.

In step 2402, the owner of a challenge gets a % control through the creating of a successful challenge. If the topic of the challenge is unallocated, the owner gets the unallocated ownership of the content/topic pie. If owner 1 expands an existing topic area or creates a new topic area, in step 2308, all ownership of the content pie is 100% allocated.

In step 2310, owner 1 claims a portion of owner 3's control.

In step 2312, owner 3 loses a % of the control and, looses the privilege to create challenges on the same scale. After loosing a percentage of control point the method goes back to step 2406. In at least one embodiment, owner 2 may choose to transfer a percentage of control of a topic to owner 3. The percentage of control that a particular player is granted may be partial control over a topic or complete control over the topic.

In an embodiment, each of the steps of method 2400 is a distinct step. In at least one embodiment, although depicted as distinct steps in FIG. 24, step 2402-2430 may not be distinct steps. In other embodiments, method 2400 may not have all of the above steps and/or may have other steps in addition to or instead of those listed above. The steps of method 2400 may be performed in another order. Subsets of the steps listed above as part of method 2400 may be used to form their own method.

System Overview

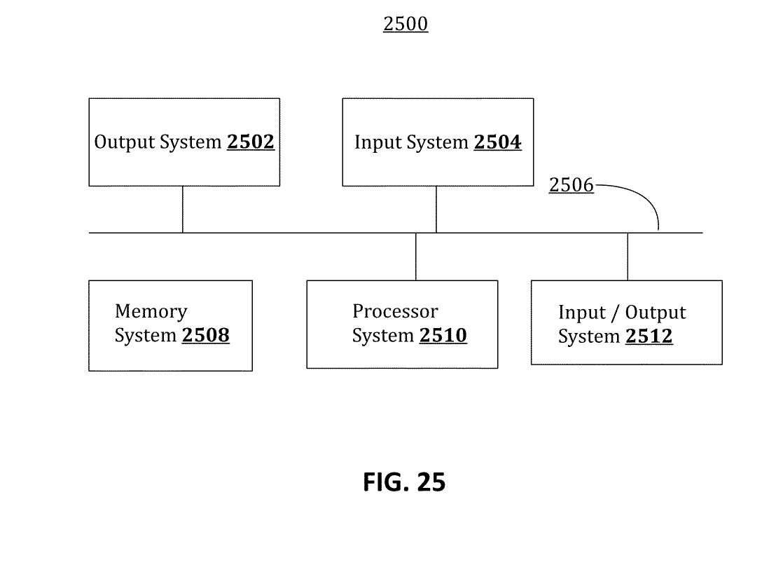

FIG. 25 illustrates an example of a block diagram of a computer system for use with a system and methods for gamifying personal development. Computer system 2500 may include embodiments of output system 2502, input system 2504, communications system 2506, memory system 2508, processor system 2510, and input/output system 2512. In other embodiments, computer system 2500 may not have all of the elements or components listed above and/or may have other elements or components instead of or in addition to those listed. Computer system 2500 is an example of a computer that may be used as computer in any of FIGS. 1-24 and 26-27.

Output system 2502 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 2504 may include any one of, some of, any combination of, or all of a keyboard system, a mouse system, a track ball system, a track pad system, buttons on a handheld system, a smayner system, a microphone system, a connection to a sound system, and/or a connection and/or interface system to a computer system, intranet, and/or internet (e.g., IrDA, USB), for example.

Communications system 2506 communicatively links output system 2502, input system 2504, memory system 2508, processor system 2510, and/or input/output system 2512 to each other. Communications system 2506 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Memory system 2508 may include, for example, any one of, some of, any combination of, or all of a long term storage system, such as a hard drive; a short term storage system, such as random access memory; a removable storage system, such as a floppy drive or a removable drive; and/or flash memory. Memory system 2508 may include one or more machine-readable mediums that may store a variety of different types of information. The term machine-readable medium is used to refer to any nontransitory machine readable medium capable carrying information that is readable by a machine. One example of a machine-readable medium is a computer-readable medium. Memory system 2508 may include control instructions for sending to controllers for controlling presentation panels.

Processor system 2510 may include any one of, some of, any combination of, or all of multiple parallel processors, a single processor, a system of processors having one or more central processors and/or one or more specialized processors dedicated to specific tasks. Processor carries out the machine instructions stored in memory system 2508.

Input/output system 2512 may include devices that have the dual function as input and output devices. For example, input/output system 2512 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 2512 is optional, and may be used in addition to or in place of output system 2502 and/or input system 2504.

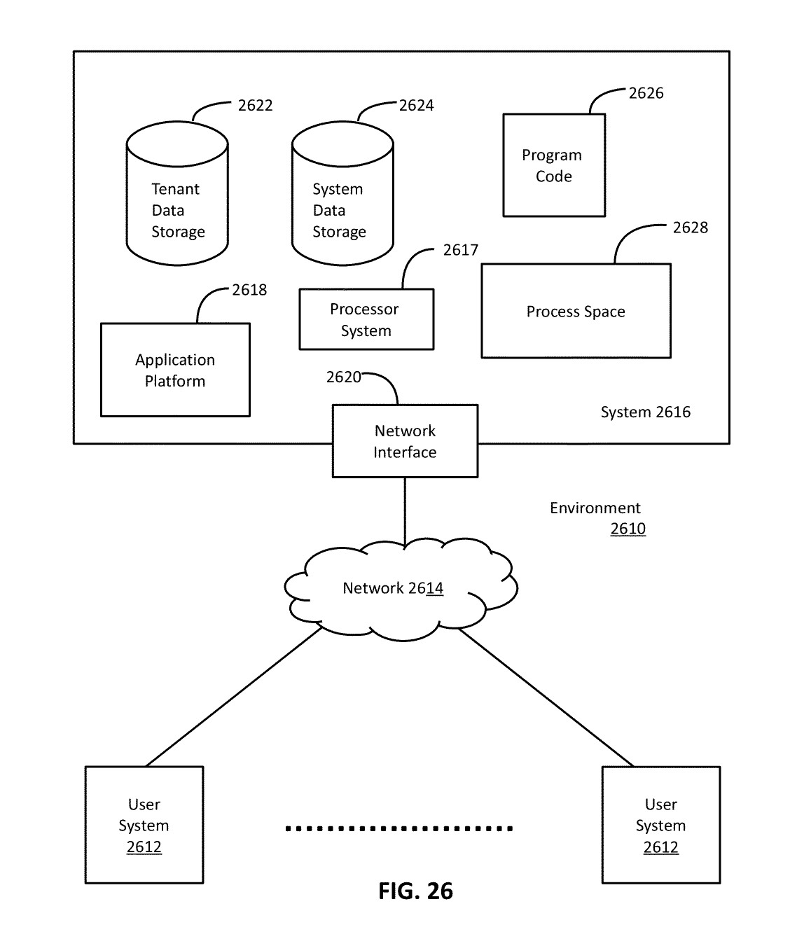

FIG. 26 illustrates a block diagram of an environment 2610 wherein an on-demand database service might be used. Environment 2610 may include user systems 2612, network 2614, system 2616, processor system 2617, application platform 2618, network interface 2620, tenant data storage 2622, system data storage 2624, program code 2626, and process space 2628. In other embodiments, environment 2610 may not have all of the components listed and/or may have other elements instead of, or in addition to, those listed above.

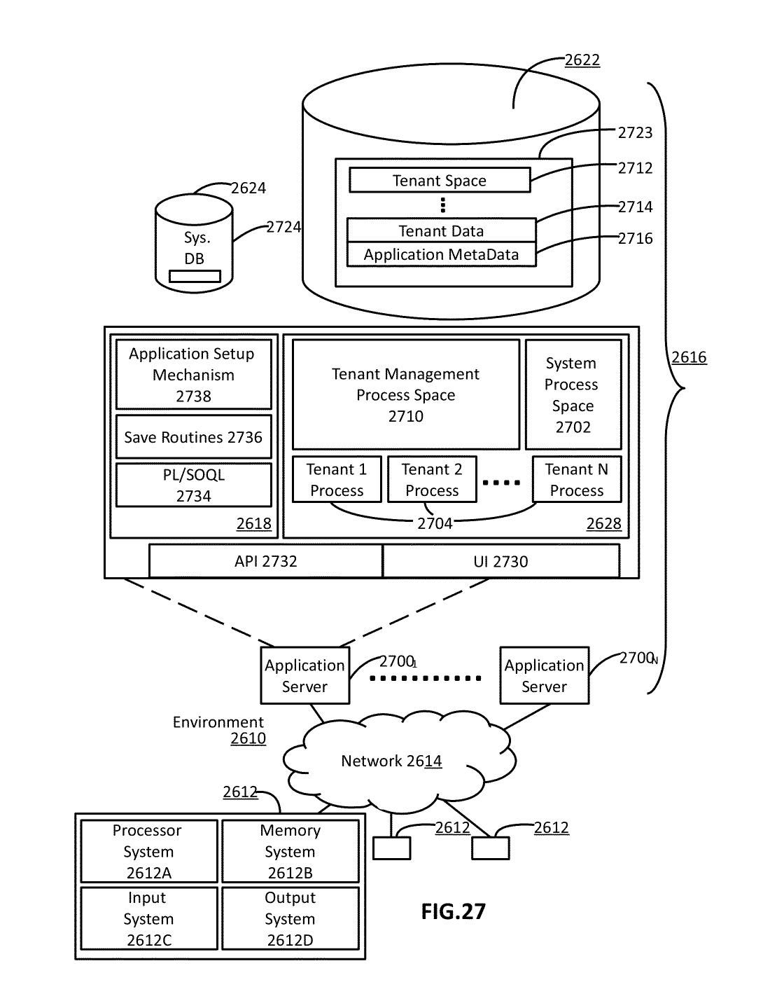

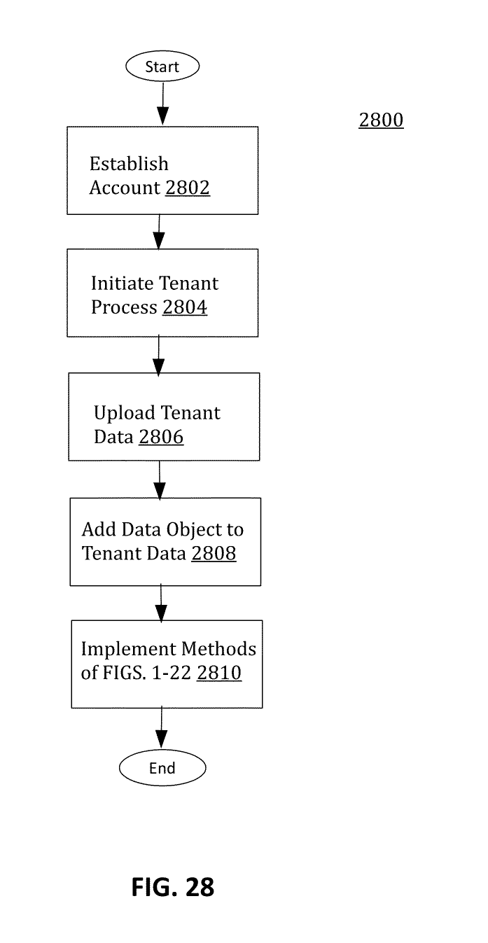

Environment 2610 is an environment in which an on-demand database service exists. User system 2612 may be any machine or system that is used by a user to access a database user system. For example, any of user systems 2612 may be a handheld computing device, a mobile phone, a laptop computer, a work station, and/or a network of computing devices. As illustrated in FIG. 26 (and in more detail in FIG. 27) user systems 2612 might interact via a network 2614 with an on-demand database service, which is system 2616.

An on-demand database service, such as system 2616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 2616” and “system 2616” will be used interchangeably herein. A database image may include one or more database objects. A relational database management system (RDMS) or the equivalent may execute storage and retrieval of information against the database object(s). Application platform 2618 may be a framework that allows the applications of system 2616 to run, such as the hardware and/or software, e.g., the operating system. In an embodiment, on-demand database service 2616 may include an application platform 2618 that enables creation, managing and executing one or more applications developed by the provider of the on-demand database service, users accessing the on-demand database service via user systems 2612, or third party application developers accessing the on-demand database service via user systems 2612.

The users of user systems 2612 may differ in their respective capacities, and the capacity of a particular user system 2612 might be entirely determined by permissions (permission levels) for the current user. For example, where a salesperson is using a particular user system 2612 to interact with system 2616, that user system has the capacities allotted to that salesperson. However, while an administrator is using that user system to interact with system 2616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 2614 is any network or combination of networks of devices that communicate with one another. For example, network 2614 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 2612 might communicate with system 2616 using TCP/IP and, at a higher network level, use other common Internet protocols to communicate, such as HTTP, FTP, AFS, WAP, etc. In an example where HTTP is used, user system 2612 might include an HTTP client commonly referred to as a “browser” for sending and receiving HTTP messages to and from an HTTP server at system 2616. Such an HTTP server might be implemented as the sole network interface between system 2616 and network 2614, but other techniques might be used as well or instead. In some implementations, the interface between system 2616 and network 2614 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 2616, shown in FIG. 26, implements a web-based customer relationship management (CRM) system. For example, in one embodiment, system 2616 includes application servers configured to implement and execute CRM software applications as well as provide related data, code, forms, webpages and other information to and from user systems 2612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 2616 implements applications other than, or in addition to, a CRM application. For example, system 2616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 2616.

One arrangement for elements of system 2616 is shown in FIG. 26, including a network interface 2620, application platform 2618, tenant data storage 2622 for tenant data 2723, system data storage 2624 for system data 2525 accessible to system 2616 and possibly multiple tenants, program code 2626 for implementing various functions of system 2616, and a process space 2628 for executing MTS system processes and tenant-specific processes, such as running applications as part of an application hosting service. Additional processes that may execute on system 2616 include database indexing processes.

Several elements in the system shown in FIG. 26 include conventional, well-known elements that are explained only briefly here. For example, each user system 2612 could include a desktop personal computer, workstation, laptop, PDA, cell phone, or any wireless access protocol (WAP) enabled device or any other computing device capable of interfacing directly or indirectly to the Internet or other network connection. User system 2612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 2612 to access, process and view information, pages and applications available to it from system 2616 over network 2614. Each user system 2612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 2616 or other systems or servers. For example, the user interface device may be used to access data and applications hosted by system 2616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks may be used instead of the Internet, such as an intranet, an extranet, a virtual private network (VPN), a non-TCP/IP based network, any LAN or WAN or the like.

According to one embodiment, each user system 2612 and all of its components are operator configurable using applications, such as a browser, including computer code run using a central processing unit such as an Intel Pentium® processor or the like. Similarly, system 2616 (and additional instances of an MTS, where more than one is present) and all of their components might be operator configurable using application(s) including computer code to run using a central processing unit such as processor system 2617, which may include an Intel Pentium® processor or the like, and/or multiple processor units. A computer program product embodiment includes a machine-readable storage medium (media) having instructions stored thereon/in which may be used to program a computer to perform any of the processes of the embodiments described herein. Computer code for operating and configuring system 2616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments may be implemented in any programming language that may be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 2616 is configured to provide webpages, forms, applications, data and media content to user (client) systems 2612 to support the access by user systems 2612 as tenants of system 2616. As such, system 2616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein may be implemented as single databases, a distributed database, a collection of distributed databases, a database with redundant online or offline backups or other redundancies, etc., and might include a distributed database or storage network and associated processing intelligence.

FIG. 25 also illustrates environment 2410. However, in FIG. 25 elements of system 2616 and various interconnections in an embodiment are further illustrated. FIG. 25 shows that user system 2612 may include processor system 2612A, memory system 2612B, input system 2612C, and output system 2612D. FIG. 26 shows network 2614 and system 2616. FIG. 25 also shows that system 2616 may include tenant data storage 2622, tenant data 2523, system data storage 2624, system data 2525, User Interface (UI) 2530, Application Program Interface (API) 2532, PL/SOQL 2534, save routines 2536, application setup mechanism 2538, applications servers 2500₁-2500_{N}, system process space 2602, tenant process spaces 2604, tenant management process space 2610, tenant storage area 2612, user storage 2614, and application metadata 2616. In other embodiments, environment 2610 may not have the same elements as those listed above and/or may have other elements instead of, or in addition to, those listed above.

User system 2612, network 2614, system 2616, tenant data storage 2622, and system data storage 2626 were discussed above in FIG. 26. Regarding user system 2612, processor system 2612A may be any combination of one or more processors. Memory system 2612B may be any combination of one or more memory devices, short term, and/or long term memory. Input system 2612C may be any combination of input devices, such as one or more keyboards, mice, trackballs, scanners, cameras, and/or interfaces to networks. Output system 2612D may be any combination of output devices, such as one or more monitors, printers, and/or interfaces to networks. As shown by FIG. 26, system 2616 may include a network interface 2620 (of FIG. 26) implemented as a set of HTTP application servers 2500, an application platform 2618, tenant data storage 2622, and system data storage 2624. Also shown is system process space 2602, including individual tenant process spaces 2604 and a tenant management process space 2610. Each application server 2500 may be configured to tenant data storage 2622 and the tenant data 2523 therein, and system data storage 2624 and the system data 2525 therein to serve requests of user systems 2612. The tenant data 2523 might be divided into individual tenant storage areas 2612, which may be either a physical arrangement and/or a logical arrangement of data. Within each tenant storage area 2612, user storage 2614 and application metadata 2616 might be similarly allocated for each user. For example, a copy of a user's most recently used (MRU) items might be stored to user storage 2614. Similarly, a copy of MRU items for an entire organization that is a tenant might be stored to tenant storage area 2612. A UI 2530 provides a user interface and an API 2532 provides an application programmer interface to system 2616 resident processes to users and/or developers at user systems 2612. The tenant data and the system data may be stored in various databases, such as one or more Oracle™ databases.

Application platform 2618 includes an application setup mechanism 2538 that supports application developers' creation and management of applications, which may be saved as metadata into tenant data storage 2622 by save routines 2536 for execution by subscribers as one or more tenant process spaces 2604 managed by tenant management process 2610 for example. Invocations to such applications may be coded using PL/SOQL 2534 that provides a programming language style interface extension to API 2532. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 2416 for the subscriber making the invocation and executing the metadata as an application in a virtual machine.

Each application server 2500 may be communicably coupled to database systems, e.g., having access to system data 2525 and tenant data 2523, via a different network connection. For example, one application server 2500₁ might be coupled via the network 2614 (e.g., the Internet), another application server 2500_{N-1} might be coupled via a direct network link, and another application server 2500_{N} might be coupled by yet a different network connection. Transfer Control Protocol and Internet Protocol (TCP/IP) are typical protocols for communicating between application servers 2500 and the database system. However, it will be apparent to one skilled in the art that other transport protocols may be used to optimize the system depending on the network interconnect used.

In certain embodiments, each application server 2500 is configured to handle requests for any user associated with any organization that is a tenant. Because it is desirable to be able to add and remove application servers from the server pool at any time for any reason, there is preferably no server affinity for a user and/or organization to a specific application server 2500. In one embodiment, therefore, an interface system implementing a load balancing function (e.g., an F5 Big-IP load balancer) is communicably coupled between the application servers 2500 and the user systems 2612 to distribute requests to the application servers 2500. In one embodiment, the load balancer uses a least connections algorithm to route user requests to the application servers 2500. Other examples of load balancing algorithms, such as round robin and observed response time, also may be used. For example, in certain embodiments, three consecutive requests from the same user could hit three different application servers 2500, and three requests from different users could hit the same application server 2500. In this manner, system 2616 is multi-tenant, wherein system 2616 handles storage of, and access to, different objects, data and applications across disparate users and organizations.

As an example of storage, one tenant might be a company that employs a sales force where each salesperson uses system 2616 to manage their sales process. Thus, a user might maintain contact data, leads data, customer follow-up data, performance data, goals and progress data, etc., all applicable to that user's personal sales process (e.g., in tenant data storage 2622). In an example of a MTS arrangement, since all of the data and the applications to access, view, modify, report, transmit, calculate, etc., may be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 2616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 2616 might also maintain system level data usable by multiple tenants or other data. Such system level data might include industry reports, news, postings, and the like that are sharable among tenants.

In certain embodiments, user systems 2612 (which may be client systems) communicate with application servers 2500 to request and update system-level and tenant-level data from system 2616 that may require sending one or more queries to tenant data storage 2622 and/or system data storage 2624. System 2616 (e.g., an application server 2500 in system 2616) automatically generates one or more SQL statements (e.g., one or more SQL queries) that are designed to access the desired information. System data storage 2624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/81<@>,161, [WHAT SHOULD THIS BE????] filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

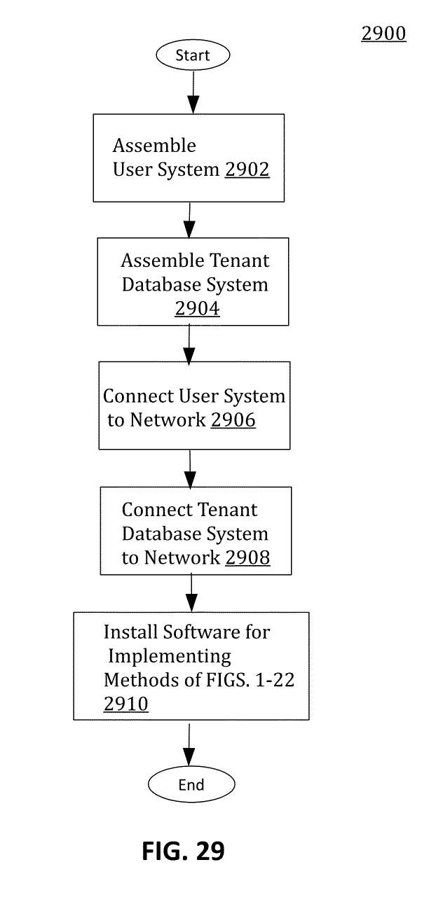

### Method for Using the Environment (FIG. 28)

FIG. 28 shows a flowchart of an example of a method 2800 of using environment 2610. In step 2810, user system 2612 (FIGS. 26 and 27) establishes an account. In step 2812, one or more tenant process space 2704 (FIG. 27) are initiated on behalf of user system 2612, which may also involve setting aside space in tenant space 2712 (FIG. 27) and tenant data 2714 (FIG. 27) for user system 2612. Step 2812 may also involve modifying application metadata to accommodate user system 2612. In step 2814, user system 2612 uploads data. In step 2816, one or more data objects are added to tenant data 2714 where the data uploaded is stored. In step 2818, the methods associated with FIGS. 1-24 may be implemented. In another embodiment, although depicted as distinct steps in FIG. 28, steps 2802-2818 may not be distinct steps. In other embodiments, method 2800 may not have all of the above steps and/or may have other steps in addition to, or instead of, those listed above. The steps of method 2800 may be performed in another order. Subsets of the steps listed above as part of method 2800 may be used to form their own method.

### Method for Creating the Environment (FIG. 29)

FIG. 29 is a method of making environment 2610, in step 2902, user system 2612 (FIGS. 26 and 27) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 2904, system 2616 (FIGS. 26 and 27) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 2616 may include installing application platform 2618, network interface 2620, tenant data storage 2622, system data storage 2624, system data 2725, program code 2626, process space 2628, UI 2730, API 2732, PL/SOQL 2734, save routine 2736, application setup mechanism 2738, applications servers 100₁-100_{N}, system process space 102, tenant process spaces 2704, tenant management process space 110, tenant space 2712, tenant data 2714, and application metadata 116 (FIG. 27).

In step 2906, user system 2612 is communicatively coupled to network 2704. In step 2908, system 2616 is communicatively coupled to network 2704 allowing user system 2612 and system 2616 to communicate with one another (FIG. 27). In step 2910, one or more instructions may be installed in system 2616 (e.g., the instructions may be installed on one or more machine readable media, such as computer readable media, therein) and/or system 2616 is otherwise configured for performing the steps of methods associated with FIGS. 1-24. In an embodiment, each of the steps of method 2900 is a distinct step. In another embodiment, although depicted as distinct steps in FIG. 29, steps 2902-2910 may not be distinct steps. In other embodiments, method 2900 may not have all of the above steps and/or may have other steps in addition to, or instead of, those listed above. The steps of method 2900 may be performed in another order. Subsets of the steps listed above as part of method 2900 may be used to form their own method.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for gamifying personal development, the method comprising:
presenting, by a machine of an organization, having a processor system having at least one processor and a memory system, a user interface having
one or more challenge-links, which when activate, cause the machine to present one or more challenges stored in the memory system to the user, the challenge being related to professional development within the organization
one or more tools, which when activated, aid in uploading and submitting solutions, via the machine, to the one or more challenges,
one or more feedback-links, which when activated, present by the machine, to the user reviews of challenges taken by the user;
receiving input, at the machine, with the aid of the one or more tools, the input including one or more solutions to the one or more challenges from the one or more players;
storing by the processor system the one or more solutions to the memory location to which access it granted to one or more players that are assigned to review the one or more solutions; and
receiving input, at the machine, from the reviewer player, the input including one or more reviews of the one or more challenges;
providing, by the processor system, the one or more reviews of the solution to the one or more players; and
awarding, by the processor system, a number of player points to the one or more players based on the difficulty of the challenge and the review by the player reviewer.

2. The method of claim 1, wherein the challenge provides one or more aspects of personal development related to a job or career.

3. The method of claim 1, awarding privileges to one or more players based on the points.

4. The method of claim 3, wherein the privileges include becoming a player reviewer.

5. The method of claim 3, awarding a player a privilege of being a reviewer based on the player's point total and on an area of expertise that the player established during the game.

6. The method of claim 1, wherein in the machine hosts an on demand, multi tenant database system.

7. The method of claim 1, wherein the points are awarded from a finite pool of points.

8. The method of claim 1, wherein user interface includes a page having one or more hints that pertain to the one or more challenges.

9. The method of claim 1, wherein the number of points is further based on the number of hints used by the player, the amount of time taken by the player, and the number of challenges the player has played.

10. A system for gamifying personal development, the system comprising:
a processor system including at least one processor;
a memory system communicatively coupled to the processor system;
the memory system storing at least one or more machine instructions which when implemented by the processor system create
an interface for creating challenges and taking challenges;
the interface including one or more tools for uploading a solution to a challenge to the machine;
the interface including one or more tools for creating a challenge;
the machine storing one or more machine instructions for awarding points to players that take a challenge and for awarding points to players that create a challenge;
presenting, by a machine having a processor system having at least one processor and a memory system, to a user one or more user interfaces, the one or more user interfaces including at least one or more pages that include tools for creating a challenge and one or more pages that include selectable challenges having tools for submitting a solution to a challenge;

11. The system of claim 10, wherein the interface includes a field into which a challenge creator enters hints for solving the challenge.

12. The system of claim 10, wherein the challenge provides one or more aspects of personal development directly related to a working in a particular organization.

13. The system of claim 10, wherein the machine includes one or more machine instructions that assign the number of points are based on the difficulty of the challenge that is created, the amount of time taken by the user to create the challenge, and the number of challenges the user has created, and the number of challenges the user has played.

14. The system of claim 10, wherein the machine includes one or more machine instructions that assign privileges to players based on how many point player has accumulated.

15. The system of claim 16, wherein a privilege is to become a player reviewer.

16. The system of claim 10, wherein the machine includes one or more machine instructions that chooses a reviewer of a challenge from the pool of players based on the player's knowledge base and the player's points.

17. The system of claim 10, wherein the system hosts a multi tenant database system.

18. The system of claim 10, wherein the machine includes one or more machine instructions that assign the points from a finite pool of points.

19. The system of claim 10, wherein the machine includes one or more machine instructions that assign the points to the challenge creator and the challenge takers based what percentage of players that took the challenge successfully solved the challenge.

20. A system for gamifying personal development including at least a machine of an organization, having a processor system having at least one processor and a memory system storing one or more machine instructions for implementing a method, the method comprising:
presenting, by the machine a user interface having
one or more challenge-links, which when activate, cause the machine to present one or more challenges stored in the memory system to the user, the challenge being related to professional development within the organization
one or more tools, which when activated, aid in uploading and submitting solutions, via the machine, to the one or more challenges,
one or more feedback-links, which when activated, present by the machine, to the user reviews of challenges taken by the user;
receiving input, at the machine, with the aid of the one or more tools, the input including one or more solutions to the one or more challenges from the one or more players;
storing by the processor system the one or more solutions to the memory location to which access it granted to one or more players that are assigned to review the one or more solutions; and
receiving input, at the machine, from the reviewer player, the input including one or more reviews of the one or more challenges;
providing, by the processor system, the one or more reviews of the solution to the one or more players; and
awarding, by the processor system, a number of player points to the one or more players based on the difficulty of the challenge and the review by the player reviewer.
